(19) United States
(12) Patent Application Publication
(10) Pub. No.: US 2013/0173696 A1
(43) Pub. Date: Jul. 4, 2013

(54) INFORMATION PROVIDING SERVICE SYSTEM AND METHOD BASED ON INTER-DEVICE INFORMATION EXCHANGE PROTOCOL

(71) Applicant: Electronics and Telecommunications Research Institute, Daejeon (KR)

(72) Inventors: Eun Seo LEE, Daejeon (KR); Hark Jin LEE, Daejeon (KR); Jun Hee PARK, Daejeon (KR)

(73) Assignee: Electronics and Telecommunications Research Institute, Daejeon (KR)

(21) Appl. No.: 13/720,220

(22) Filed: Dec. 19, 2012

(30) Foreign Application Priority Data
Dec. 29, 2011 (KR) 10-2011-0145562
Mar. 23, 2012 (KR) 10-2012-0029824

(51) Int. Cl. H04L 29/06

(52) U.S. Cl. CPC H04L 67/42
USPC 709/203

(57) ABSTRACT

Provided is an information providing service system and method based on an inter-device information exchange protocol. The information providing service system includes a plurality of devices on which a device architecture module and an information provision application for performing information exchange and remote control in a specific network are installed, and an information provision server configured to receive position information periodically transmitted by the information provision application of the respective devices, manage the position information according to the respective devices, receive a signal generated by a sensing means installed at a predetermined position in a specific place, find a position of the generated signal, search for the same device position information as the found position using an information provision application service module, and transmit predetermined guide information data to the information provision application of a device corresponding to the searched device position information.

### CLAIM FOR PRIORITY

This application claims priority to Korean Patent Application No. 10-2011-0145562 filed on Dec. 29, 2011 and No. 10-2012-0029824 filed on Mar. 23, 2012 in the Korean Intellectual Property Office (KIPO), the entire contents of which are hereby incorporated by reference.

### BACKGROUND

1. Technical Field

Example embodiments of the present invention relate in general to an information providing service system and method based on an inter-device information exchange protocol, and more particularly, to an information providing service system and method based on an inter-device information exchange protocol that synthetically use and manage information provided from several layers, such as a network layer and a service layer, as well as a device layer on the basis of a standardized protocol in a home network environment and thereby enable performance of device control, management, automatic configuration, and other functions.

2. Related Art

In general, the term “home network” commonly refers to total home information control systems and services/solutions that implement information technology elements in a house (building) rather than a simple network connection in a home along with Internet-based informatization.

Middleware is a programming service that arbitrates between two or more systems or programs. However, there has been a problem of interoperability between home devices connected with different types of home network middleware.

Korean Patent Application No. 2005-207263 discloses a universal home network middleware bridge system and method for interoperability between such home devices connected with different types of home network middleware. The application provides a universal home network middleware bridge system and method for interoperability between home devices connected with different types of home network middleware, the system and method virtually showing all devices connected with the different types of home network middleware as if they were actual physical devices connected with the same middleware, and thereby enabling device connection/disconnection, device control, and event registration/occurrence notification to be managed according to the corresponding existing middleware mechanisms without modifying the corresponding pieces of middleware.

However, Korean Patent Application No. 2005-207263 does not relate to a new home network system capable of synthetically managing information provided from several layers such as a device layer and a network service layer on the basis of a standardized protocol, but relates to a bridge system for interoperability between existing home network protocols or middleware.

In addition, Korean Patent Application No. 2002-0010935 discloses an apparatus and method for providing compatibility of a home network system allowing products, which can constitute a home network and to which various communication standards are applied, to become compatible with each other. According to Korean Patent Application No. 2002-0010935, it is possible to cause a standard of a group of appliances operating with Windows XP supporting universal plug and play (UPnP) and a standard of a group of general appliances employing a low-level controller such as an 8-bit micro-computer (MICOM) to become compatible with each other, such that a home network can be configured between products to which the different standards are applied. However, this application also does not relate to a new home network system capable of synthetically managing information provided from several layers such as a device layer and a network service layer on the basis of a standardized protocol.

Thus, there has been a necessity for a device architecture (DA) structure capable of synthetically using and managing information provided from several layers, such as a network layer and a service layer, as well as a device layer on the basis of a standardized protocol in a home network environment, that is, a DA structure focused on providing compatibility between devices or services.

Currently, Korean electronics companies and home network companies are producing commercial products according to open standards, but are technologically dependent on foreign companies because they cannot provide a new DA structure for a convergence environment.

### SUMMARY

Accordingly, example embodiments of the present invention are provided to substantially obviate one or more problems due to limitations and disadvantages of the related art.

Example embodiments of the present invention provide an information providing service system and method based on an inter-device information exchange protocol that synthetically use and manage information provided from several layers, such as a network layer and a service layer, as well as a device layer on the basis of a standardized protocol in a home network environment, and thereby enable performance of device control, management, automatic configuration, and other functions.

In some example embodiments, an information providing service system based on an inter-device information exchange protocol includes: a plurality of devices on which a device architecture (DA) module and an information provision application for performing information exchange and remote control in a specific network on the basis of the standardized information exchange protocol are installed; and an information provision server configured to receive position information periodically transmitted by the information provision application of the respective devices, manage the position information according to the respective devices, receive a signal generated by a sensing means installed at a predetermined position in a specific place, find a position of the generated signal, search for the same device position information as the found position using an information provision application service module, and transmit predetermined guide information data to the information provision application of a device corresponding to the searched device position information.

Here, the information provision server may receive device information from the respective devices, and transmit the information provision application to the respective devices such that the information provision application is installed according to platforms of the respective devices.

Each of the devices may perform device authentication through the information provision server, and then may automatically transmit its own device information to the information provision server when the device connects to a wired/wireless access point (AP) prepared on the network.

The sensing means may be a human body sensor or a wired/wireless sensor switch.

The specific place may be a place in which a guide and information provision service for at least one of a building, a historical site and an object is provided.

The information provision application installed on the device corresponding to the searched device position information may receive the guide information data transmitted from the information provision server and display the guide information data on a screen such that the corresponding user can see the guide information data.

The DA module installed on each of the devices may include: an advertisement manager configured to announce a status change of the device on the network; an event manager configured to transmit event information to a specific device having requested a subscription when a specific event occurs on the network; a file manager configured to perform file transmission and reception and a function for a specific file, and manage a result of the file transmission and reception and a result of the function for the specific file; and a message manager configured to generate a message and analyze a message.

The DA module may further include: a discovery manager configured to search for the specific device on the network; an information manager configured to request and receive information from the specific device on the network; and a control manager configured to control a device or a service using various device-specific functions.

The message manager may include: a message generator configured to generate the message; and a message parser configured to analyze the message, and the messages may include a header and a payload.

The header may include a start signal, a source device identifier (ID), a target device ID, an operation (OP) code, and an end signal.

The discovery manager may use a device discovery request message including at least one parameter among a device ID or name, and a device type or capability as a device discovery condition, and a device discovery response message in which information about a device satisfying the condition is generated as a payload.

The advertisement manager may use a device advertisement message including at least one parameter among the number of the devices, a device ID or name, a device type or capability, and a network participation information parameter.

The information manager may use a device information request message including a type parameter of the device information, and a device information response message for, when information is requested by a specific device, responding with the information according to a type of the requested information.

The device information type parameter may include at least one piece of information among basic information about the device, device-specific function list information, device property information, common property information about the device, configuration information about the device, status information about the device, and device-specific unique property information.

The device information response message may include at least one piece of information among basic information about the device, device-specific function list information, device property information, common property information about the device, configuration information about the device, status information about the device, and device-specific unique property information. Here, the basic information about the device may include a device ID, a device type, a device name, and information about a list of several unique functions supported by a complex device, and the device-specific function list information may include the number of functions provided by the device, function IDs defined according to the device, categories of the functions, a list of messages input to the device for performing a specific function, or a list of messages output from the device.

The control manager may use a device control request message including at least one parameter among a function ID including a device type code and a function list category, a function category, an input list, and an output list, and a device control response message including the same parameter as the device control request message.

The event manager may use an event notification message including at least one parameter among a function ID, a function category, and an event list, an event subscription request message including at least one parameter among a function ID, a subscription interval, and a subscription type, and an event subscription response message including a result parameter.

The file manager may use a file information request message including at least one parameter among a file type, a file name, a search start time, and a search end time required for a file transmission and reception process, and a file information response message including a file information list parameter.

The file information list may include at least one piece of information among the file name, the file type, a file size, a file creation date, a file uniform resource locator (URL), and a file version.

The file manager may use a file transmission request message including at least one parameter among a target device position, a local device position, and a file name, a file transmission response message including an error code, and a file transmission result message about a transmission error or a transmission result.

The file manager may use a function performance request message including at least one of execution of a specific file, service update, rollback, file addition, and file deletion, a function performance response message including an error code, and a result message about a function performance error or a function performance result.

The DA module may further include a maintenance manager configured to manage remote maintenance of the devices.

The maintenance manager may provide a firmware update function, a configuration function, a file up/download function, or a rollback/reboot function.

In other example embodiments, an information providing service method based on an inter-device information exchange protocol using a system including a plurality of devices on which a DA module and an information provision application for performing information exchange and remote control in a specific network on the basis of the standardized information exchange protocol are installed, and an information provision server, includes: (a) periodically transmitting, at the information provision application installed on the respective devices, position information about the respective devices; (b) receiving, at the information provision server, the position information transmitted from the respective devices and managing the position information according to the respective devices; (c) receiving, at the information provision server, a signal generated by a sensing means installed at a predetermined position in a specific place and finding a position of the generated signal; (d) searching for, at an information provision application service module prepared in the information provision server, the same device position information as the position found in step (c); and (e) transmitting predetermined guide information data to the information provision application of a device corresponding to the device position information searched in step (d).

Here, the information providing service method may further include, before step (a), receiving, at the information provision server, device information from the respective devices and transmitting the information provision application to the respective devices such that the information provision application is installed according to platforms of the respective devices.

Each of the devices may perform device authentication through the information provision server, and then may automatically transmit its own device information to the information provision server when the device connects to a wired/wireless AP prepared on the network.

The sensing means may use a human body sensor or a wired/wireless sensor switch.

The specific place may be a place in which a guide and information provision service for at least one of a building, a historical site and an object is performed.

The information providing service method may further include, after step (e), receiving, at the information provision application installed on the device corresponding to the searched device position information, the guide information data transmitted from the information provision server and displaying the guide information data on a screen such that the corresponding user can see the guide information data.

### BRIEF DESCRIPTION OF DRAWINGS

Example embodiments of the present invention will become more apparent by describing in detail example embodiments of the present invention with reference to the accompanying drawings, in which:

FIG. 1 is a diagram schematically illustrating an information providing service system based on an inter-device information exchange protocol according to an example embodiment of the present invention;

FIG. 2 is a detailed block diagram of a device architecture (DA) module applied to an example embodiment of the present invention;

FIG. 3 is a conceptual diagram illustrating a constitution of a message of a DA applied to an example embodiment of the present invention;

FIG. 4 is a diagram showing an example extensible markup language (XML) schema structure of a “DEVICE_DISCOVERY_REQUEST” message;

FIG. 5 is a diagram showing an example XML schema structure of a “DEVICE_DISCOVERY_RESPONSE” message;

FIG. 6 is a diagram showing an example XML schema structure of a “DEVICE_ADVERTISEMENT” message;

FIG. 7 is a diagram showing an example XML schema structure of a “DEVICE_INFO_REQUEST” message;

FIG. 8 is a diagram showing an example XML schema structure of a “DEVICE_INFO_RESPONSE” message;

FIG. 9 is a diagram showing an example XML schema structure of a “BASIC_INFO” message;

FIG. 10 is a diagram showing an example XML schema structure of a “FUNCTION_LIST” message;

FIG. 11 is a diagram showing an example XML schema structure of a “DEVICE_PROPERTY” message;

FIG. 12 is a diagram showing an example XML schema structure of a “DEVICE_CONTROL_REQUEST” message;

FIG. 13 is a diagram showing an example XML schema structure of a “DEVICE_CONTROL_RESPONSE” message;

FIG. 14 is a diagram showing an example XML schema structure of an “EVENT_NOTIFICATION” message;

FIG. 15 is a diagram showing an example XML schema structure of an “EVENT_SUBSCRIPTION_REQUEST” message;

FIG. 16 is a diagram showing an example XML schema structure of an “EVENT_SUBSCRIPTION_RESPONSE” message;

FIG. 17 is a diagram showing an example XML schema structure of a “GET_FILEINFO_REQUEST” message;

FIG. 18 is a diagram showing an example XML schema structure of a “GET_FILEINFO_RESPONSE” message;

FIG. 19 is a diagram showing an example XML schema structure of a “GET_FILE_REQUEST” message;

FIG. 20 is a diagram showing an example XML schema structure of a “GET_FILE_RESPONSE” message;

FIG. 21 is a diagram showing an example XML schema structure of a “GET_FILE_RESULT” message;

FIG. 22 is a diagram showing an example XML schema structure of a “PUT_FILE_REQUEST” message;

FIG. 23 is a diagram showing an example XML schema structure of a “PUT_FILE_RESPONSE” message;

FIG. 24 is a diagram showing an example XML schema structure of a “PUT_FILE_RESULT” message;

FIG. 25 is a diagram showing an example XML schema structure of an “APPLY_REQUEST” message;

FIG. 26 is a diagram showing an example XML schema structure of an “APPLY_RESPONSE” message;

FIG. 27 is a diagram showing an example XML schema structure of an “APPLY_RESULT” message; and

FIG. 28 is an overall flowchart illustrating an information providing service method based on an inter-device information exchange protocol according to an example embodiment of the present invention.

### DESCRIPTION OF EXAMPLE EMBODIMENTS OF THE PRESENT INVENTION

Hereinafter, example embodiments of the present invention will be described in detail with reference to the appended drawings. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

First, in an example embodiment of the present invention, an art gallery is used as an example in which an information providing service system is implemented. However, the present invention is not limited to an art gallery, and the system according to example embodiments of the present invention can be implemented in any place as long as a guide and information provision service for at least one of a building such as a museum or exhibition hall, a historic site, and an object is provided.

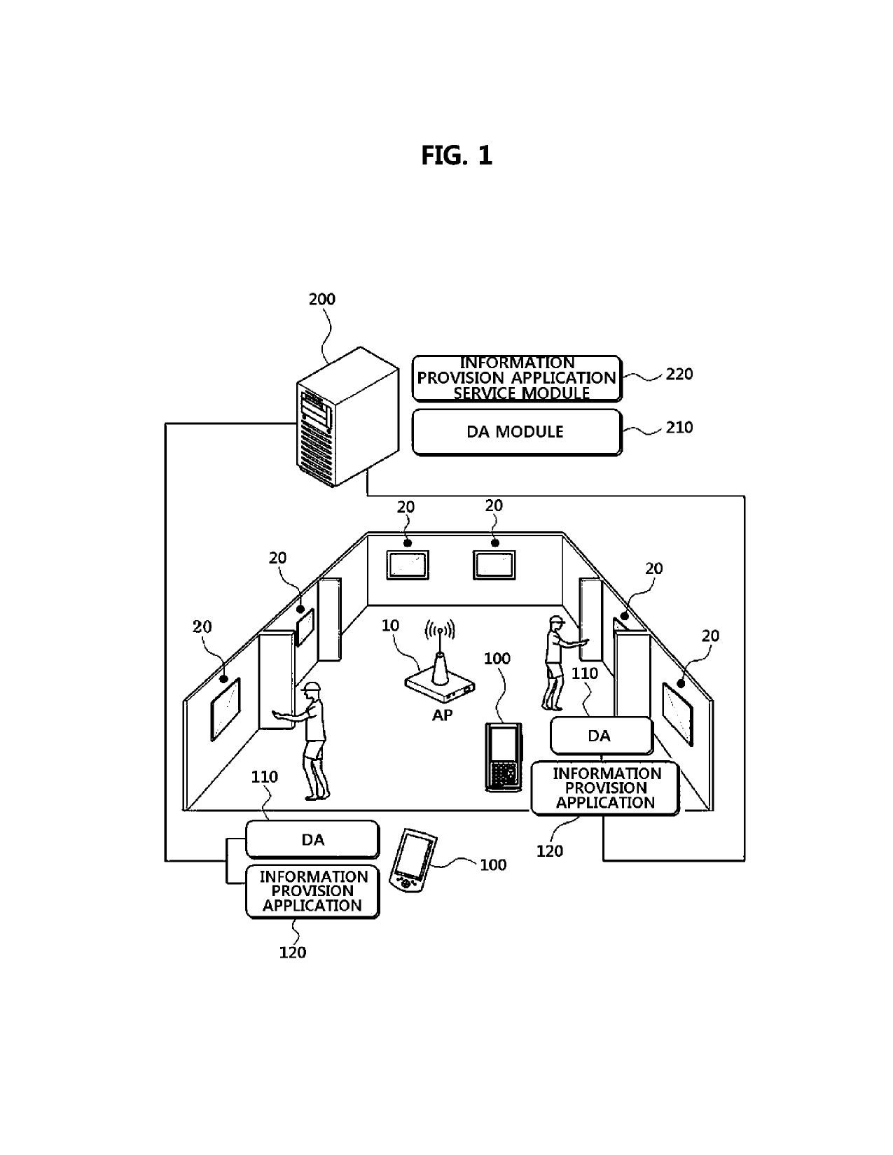

FIG. 1 is a diagram schematically illustrating an information providing service system based on an inter-device information exchange protocol according to an example embodiment of the present invention.

Referring to FIG. 1, an information providing service system based on an inter-device information exchange protocol according to an example embodiment of the present invention generally includes a plurality of devices 100 and an information provision server 200 that provides an information provision service. For example, in a home network environment, the plurality of devices 100 are connected with the information provision server 200 that provides a device control service, a device management service, an automatic device configuration service, an information provision service, and other services via a wired/wireless network.

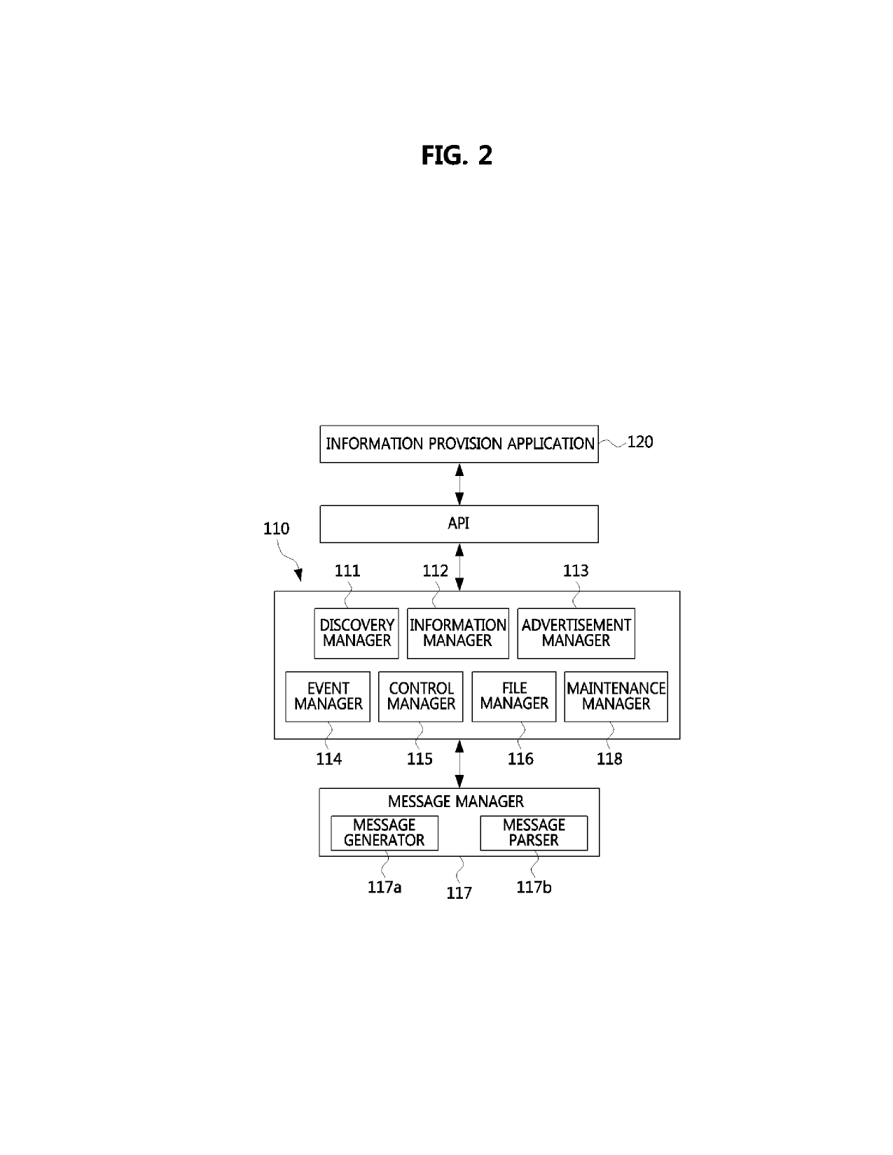

In the plurality of devices 100, a device architecture (DA) module 110 and an information provision application 120 for performing information exchange and remote control on the basis of a standardized information exchange protocol, that is, a standard message protocol, in a specific wired/wireless network are installed. Here, the standard message protocol is referred to as a DA, and a basic constitution of the DA module 110 is shown in FIG. 2.

In other words, the DA module 110 is installed on each of the devices 100, and the information provision application 120 employing a DA application program interface (API) is installed on an upper layer of the DA module 110. These devices 100 may be implemented as, for example, sensor devices, information devices, home appliances, network devices, and built-in devices.

The information provision application 120 installed on each of these devices 100 functions to receive guide information data transmitted from the information provision server 200 and display the guide information data on a screen such that the corresponding user can see the data.

Meanwhile, each of the devices 100 may perform device authentication through the information provision server 200, and then may automatically transmit its own device information to the information provision server 200 when the device 100 connects to a wired/wireless access point (AP) 10 prepared on the wired/wireless network.

The information provision server 200 functions to receive position information periodically transmitted by the information provision application 120 installed on the respective devices 100, and manage the position information according to the respective devices 100.

In addition, the information provision server 200 functions to receive a signal generated by a sensing means 20 installed at a predetermined position in a specific place, find a position of the generated signal, search for the same device position information as the found position using an information provision application service module 220, and then transmit predetermined guide information data to the information provision application 120 of a device 100 corresponding to the searched device position information.

Furthermore, the information provision server 200 may receive device information (e.g., operating systems (OSs), platforms, and versions) from the respective devices 100 and transmit the information provision application 120 to the respective devices 100 such that the information provision application 120 is installed according to the platforms of the respective devices 100.

Meanwhile, the sensing means 20 may be generally implemented as a human body sensor, a wired/wireless sensor switch, etc. capable of sensing a human body. However, the sensing means 20 is not limited to the human body sensor, the wired/wireless switch, etc., but can be anything that senses a human body and outputs a predetermined signal.

The specific place may be a place in which a guide and information provision service for at least one of a building such as an art gallery, a museum or an exhibition hall, a historical site, and an object is provided.

Like the plurality of devices 100, the information provision server 200 also includes a DA module 210 and an information provision application, that is, the information provision application service module 220. The variety of devices 100 and the information provision server 200 exchange device information with each other, and specific control services are used between them.

Such a DA is necessary to solve the problem of interoperability between main home network devices, for example, a home gateway, a wall pad, and a television (TV), and to share a home network service architecture.

In other words, a DA provides device information and status information, and provides functions, such as network initialization, device initialization and topology discovery, for automatic device configuration.

Also, a DA provides functions for remote maintenance such as firmware update, configuration, file up/download and rollback/reboot, and provides functions for device monitoring/control such as remote control, logging and reboot.

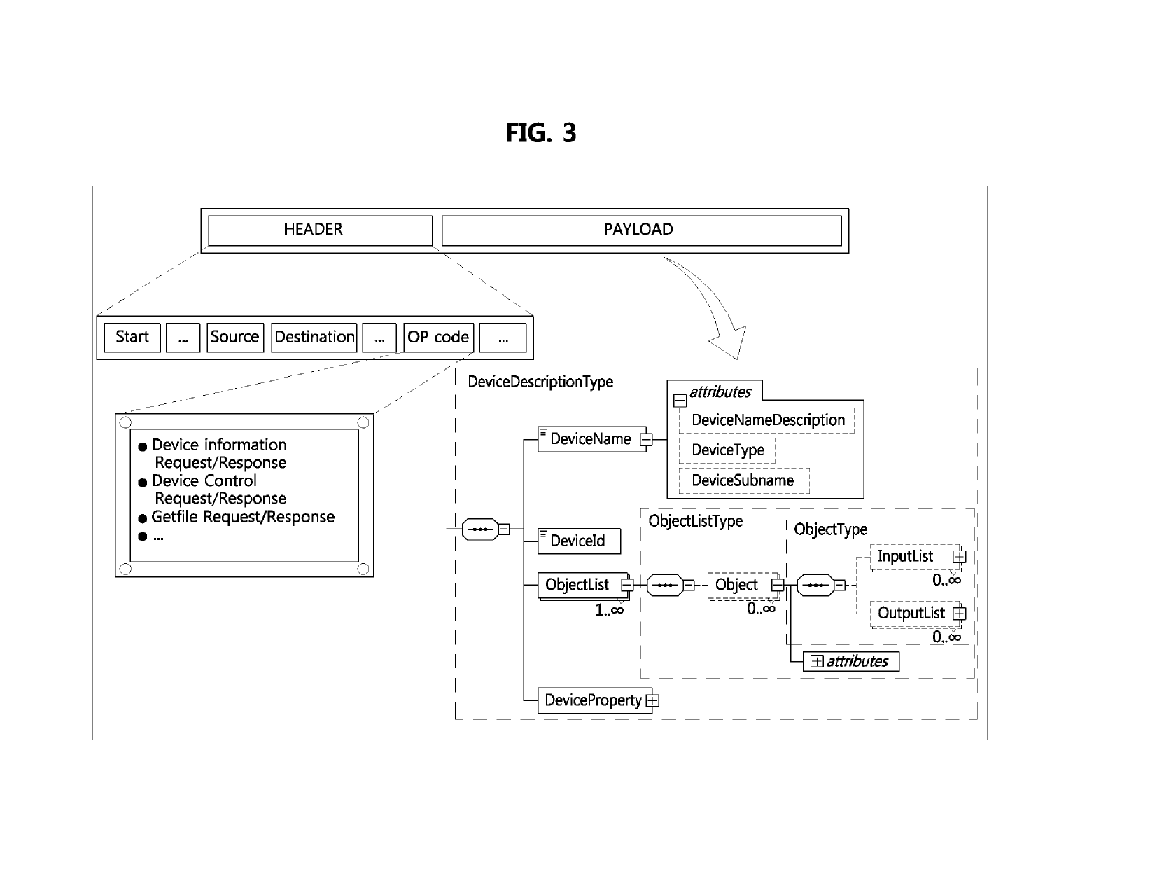

FIG. 2 is a detailed block diagram of a DA module applied to an example embodiment of the present invention, and FIG. 3 is a conceptual diagram illustrating a constitution of a message of a DA applied to an example embodiment of the present invention.

Referring to FIG. 2 and FIG. 3, an information provision application 120 that basically manages devices in a home network employs an API provided by a DA, and a DA module 110 includes a discovery manager 111, an information manager 112, an advertisement manager 113, an event manager 114, a control manager 115, a file manager 116, and a maintenance manager 118.

The DA module 110 communicates with an information provision server 200 using a message generator 117a and a message parser 117b of a message manager 117. The message generator 117a generates a standard message stream for performing a unique role of each manager, and the message parser 117b serves to analyze a received standard message stream and transfer the analysis result to the corresponding manager.

Such a message provides status information about devices and the network, supports automatic device configuration through a network initialization function, a device initialization function, etc., and may have a structure as shown in FIG. 3.

Referring to FIG. 3, a message of a DA may include a header and a payload. The header may be a binary stream, and the payload may be extensible markup language (XML) data.

The header consists of a start signal, a source device identifier (ID), a target device ID, an operation (OP) code, an end signal, etc., and particularly, various functions provided by the DA are defined in the OP code.

Thus, when a DA message is received, the DA module 110 basically analyzes a header, and then transfers a payload to the corresponding manager according to an OP code. As an ID shared by specific request and response messages, a transaction ID among header fields is time information generated with respect to a request message generation time. For a response, a message is generated using this ID. Content of a DA header structure is described in detail in Table 1 below by way of example.

TABLE 1

| | Size | |
|---|---|---|
| Field Name | (Byte) | Description |
| MessageStart | 2 | Magic code indicating start of message |
| Version | 1 | DA protocol version (= 1) |
| Flag | 1 | Urgen, |
| Length | 4 | Message size (including header) |
| Message ID | 4 | Payload XML ID |
| Sequence Number | 4 | Partial sequence number for specific XML |
| Source ID | 20 | Message generation node ID |
| Destination ID | 20 | Message destination node ID |
| OP Code | 2 | Operation code |
| Transaction ID | 4 | Transaction ID, that is, time at which |
| | | request transaction is initiated |
| CRC | 4 | Message error check code |
| Optional | Variable | Variable header dependent on OP code, |
| Header/DATA | | or data defined by user |
| MessageEnd | 2 | Magic code indicating end of message |

DA functions are provided through the OP code included in the DA message header. Main functions provided through the OP code are functions for automatic device configuration and remote maintenance, such as provision of device and status information, zero configuration, remote diagnosis, and healing, and these functions are performed by the corresponding managers.

These functions may be implemented as an open API and designed to be used in an interoperable home network middleware system. Examples of an OP code are shown in Table 2 below.

TABLE 2

| Transaction | OP Name | Code | Description |
|---|---|---|---|
| Device | DEVICE_DISCOVERY_REQUEST | 0x1111 | Discovery of device |
| Discovery | DEVICE_DISCOVERY_RESPONSE | 0x1112 | satisfying specific |
| | | | condition |
| Device | DEVICE_ADVERTISEMENT | 0x1121 | Transmission of |
| Advertisement | | | information about |
| | | | status change of device |
| Device Info | DEVICE_INFO_REQUEST | 0x2011 | Device (network) |
| | DEVICE_INFO_RESPONSE | 0x2012 | description |
| | | | Device/network state |
| Device | DEVICE_CONTROL_REQUEST | 0x2111 | Device control |
| Control | DEVICE_CONTROL_RESPONSE | 0x2112 | |
| Event | EVENT_NOTIFICATION | 0x2FF1 | Status change of |
| | | | device/network |
| | | | Sensor data |
| | | | User-defined event |
| Event | EVENT_SUBSCRIPTION_REQUEST | 0x2F11 | Request event |
| Subscription | EVENT_SUBSCRIPTION_RESPONSE | 0x2F12 | registration/cancellation |
| | | | Result of request |
| GET FILE | GET_FILEINFO_REQUEST | 0x2211 | File information request |
| INFO | GET_FILEINFO_RESPONSE | 0x2212 | Result of file |
| | | | information request |
| GET FILE | GET_FILE_REQUEST | 0x2221 | File transmission |
| | GET_FILE_RESPONSE | 0x2222 | request (EXE, |
| | GET_FILE_RESULT | 0x2223 | firmware, and |
| | | | configuration) |
| | | | File transmission result |
| PUT FILE | PUT_FILE_REQUEST | 0x2231 | File reception |
| | PUT_FILE_RESPONSE | 0x2232 | acceptance request |
| | PUT_FILE_RESULT | 0x2233 | Whether or not file |
| | | | reception request is |
| | | | accepted |
| | | | Transmission of file |
| | | | transmission result |
| APPLY | APPLY_REQUEST | 0x2311 | Rollback/file (EXE, |
| | APPLY_RESPONSE | 0x2312 | firmware, and |
| | APPLY_RESULT | 0x2313 | configuration) |
| User Defined | USER Defined Operation | 0x8000~0xFFFF | Transaction defined by |
| Transaction | | | user |

A DA protocol may provide a specific feature value and function according to a type of a device. Examples of device types and codes are shown in Table 3 below. A device code may be presented by a total of two bytes. The first byte may be used to indicate a device category, and the second byte may be used for device classification in the device category.

TABLE 3

| Device | Home | Home | Internet | | | |
|---|---|---|---|---|---|---|
| Type | Gateway/Server | Information | Consume | Automation | Audio/Video | Miscellaneous |
| Code | 11XX | 12XX | 13XX | 14XX | 15XX | 1FXX |
| 01 | Home gateway | Phone | Refrigerator | Light | Audio speaker | VIOCS |
| 02 | Home server | PDA | Air conditioner | Gas valve | HIFI audio | UPS |
| 03 | Digital cable STB | PC | Microwave | Curtain | Camcorder | Complex server |
| 04 | Digital satellite STB | Home pad | Boiler | Power meter | Camera | Network device |
| 05 | Digital DMB STB | Video phone | Oven | Door lock | Scanner | Open/close sensor |
| 06 | Digital IP STB | Smart TV | Laundry | HVAC | Printer | Auto parcel |
| 07 | Wall pad | Etc | Running machine | Batch breaker | Display | Etc |
| 08 | Etc | | Health device | Security | CCTV | |
| 09 | | | Coffee machine | Thermostat | Etc | |
| 0A | | | Etc | Door bell | | |
| 0B | | | | Etc | | |

In a DA protocol, codes of various errors that may occur in a message transfer process or a specific service process may be defined. Basically, error codes may be presented by 2-byte hex codes, and may be generally classified as common errors, device-specific errors and user-defined errors.

Among these errors, common errors denote various errors relating to DA protocol OP codes, and may include an OP error, a transaction error, a file-related error, and so on. Device-specific errors occur in a specific service process according to each device. User-defined errors are specific errors relating to a specific service.

Referring back to FIG. 2, the respective managers of the DA module 110 will be described in detail.

The discovery manager 111 functions to discover a specific device on the home network using a “DEVICE_DISCOVERY_REQUEST” message and a “DEVICE_DISCOVERY_RESPONSE” message. The “DEVICE_DISCOVERY_REQUEST” message is a request message for a specific device or service to perform discovery on a specific condition in order to know what kinds of devices are currently connected with the network, and what basic information about the devices is. Table 4 below shows an example of a structure of a payload message that should be generated with the “DEVICE_DISCOVERY_REQUEST” message.

TABLE 4

| OP Code | Parameter | Size | Description | Condition |
|---|---|---|---|---|
| Device | DiscoveryReqType | 16 bytes | Char[16] | M |
| Discovery | | | All | |
| Request | | | DeviceID | |
| (0x1111) | | | DeviceType | |
| | | | DeviceName | |
| | | | Capability | |
| | StrTypeReq | 20 bytes | Char[20] | O |
| | | | (DeviceID, | |
| | | | DeviceName) | |
| | HexTypeReq | 2 bytes | Hex | O |
| | | | (DeviceType, | |
| | | | DeviceCapability) | |

Referring to parameters, “DiscoveryReqType” denotes a condition for discovery. In other words, “DiscoveryReqType” determines whether to search all devices, whether to perform the discovery according to device types, and whether to perform a discovery on the basis of a device name or a device capability, and may be presented by a 16-byte string.

“StrTypeReq” presents actual “DeviceID” and “DeviceName” values to be detected when the aforementioned “DiscoverReqType” parameter is “DeviceID” or “DeviceName,” and “HexTypeReq” presents “DeviceType” and “DeviceCapability” values to be detected as hexadecimal numbers when the “DiscoverReqType” parameter is “DeviceType” or “DeviceCapability.”

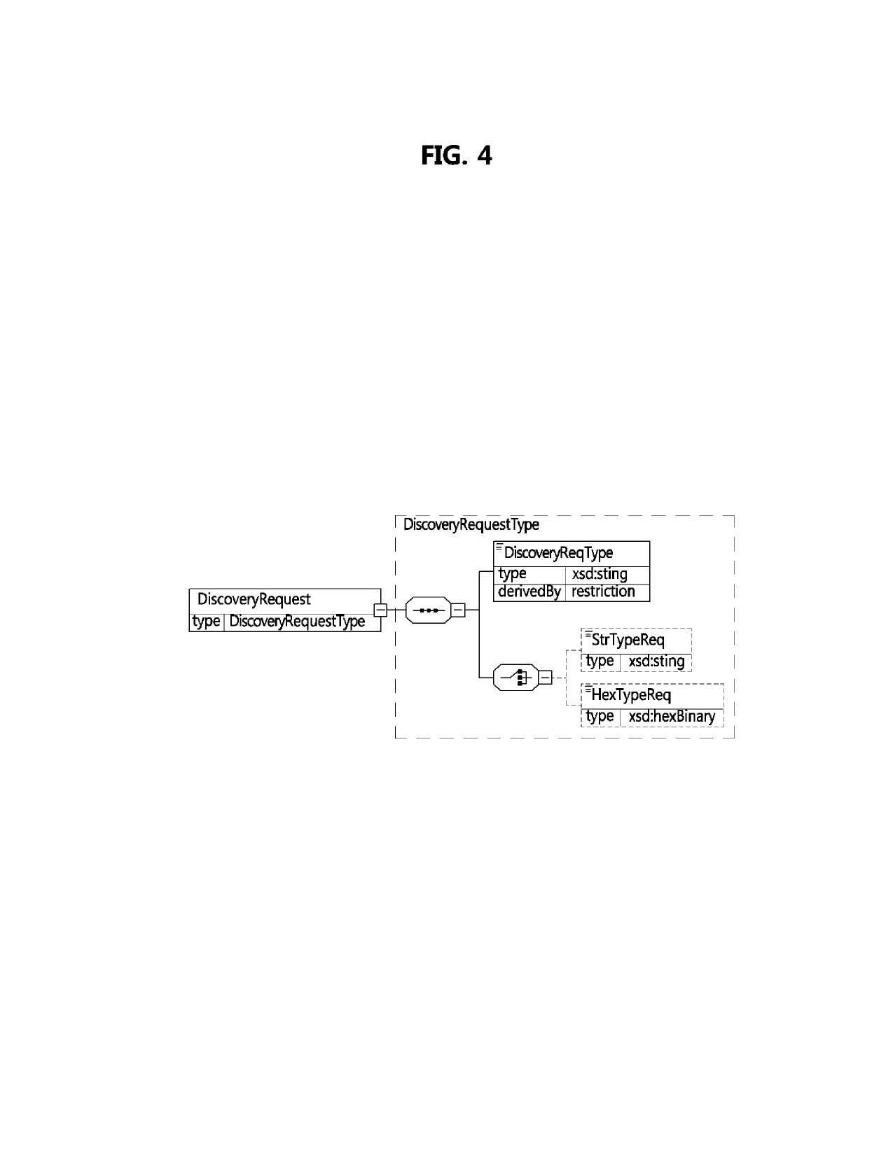

When “DiscoverReqType” is “All,” “StrTypeReq” and “HexTypeReq” are not presented. An XML schema structure of a payload message structure of the aforementioned “DEVICE_DISCOVERY_REQUEST” message may be as shown in FIG. 4.

“DEVICE_DISCOVERY_RESPONSE” is a response message to “DEVICE_DISCOVERY_REQUEST,” and information about devices satisfying a requested discovery condition is generated as an XML-based payload. Table 5 and Table 6 below show examples of a payload message structure of “DEVICE_DISCOVERY_RESPONSE.”

TABLE 5

| OP Code | Parameter | Size | Description | Condition |
|---|---|---|---|---|
| Device Discovery | Result | 2 bytes | Result code | M |
| Response (0x1112) | DeviceList | Variable | DeviceList type | — |

TABLE 6

| Data | Parameter | | | | |
|---|---|---|---|---|---|
| Structure | (Condition) | Sub Parameter | Size | Description | Condition |
| DeviceList | NumOfDevice | — | 2 bytes | Integer | M |
| Type | (M) | | | | |
| | BasicInfo | DeviceID | 20 bytes | Char[20] | M |
| | (M) | DeviceType | 2 bytes | Device type | M |
| | | DeviceName | 16 bytes | Char[16] | M |
| | | DeviceSubName | 16 bytes | Char[16] | M |
| | | DeviceCapabilityList | Variable | DeviceCapabilityList | O |
| | | | | type | |

Referring to parameters, “Result” is information denoting whether or not a response to “DEVICE_DISCOVERY_REQUEST” has been processed. “Result” presents a hex value “0000” when the response has been successfully processed, and may be presented by the aforementioned error codes when an error has occurred.

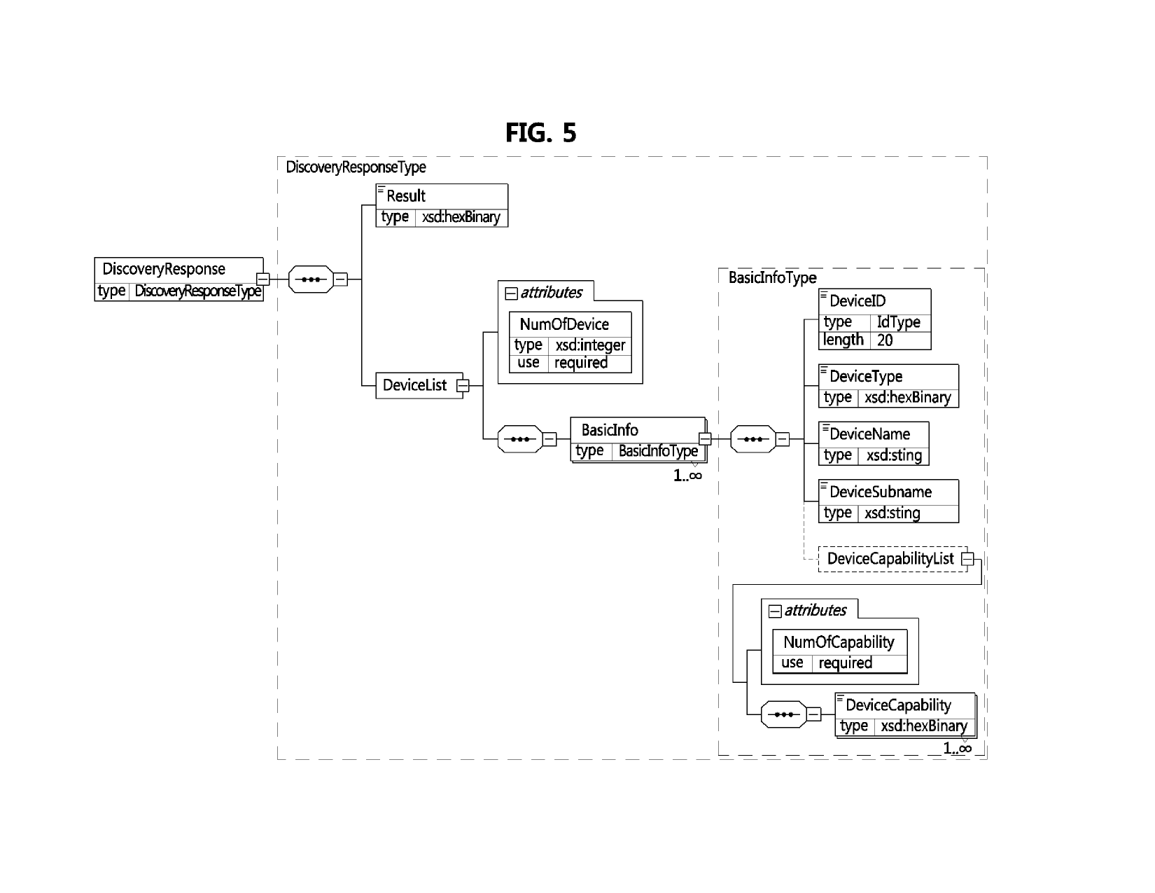

“DeviceList” denotes basic information about devices that respond to an actual request, and includes the number of the devices NumOfDevice, device IDs, device types, device names, and device-supported functions. An XML schema structure of a payload message structure of the aforementioned “DEVICE_DISCOVERY_RESPONSE” message may be as shown in FIG. 5.

An example of a device discovery process will be described. First, when a service is initially connected to the network, or a discovery command is given by an application, the discovery manager 111 transmits a “DEVICE_DISCOVERY_REQUEST” message. In this process, the message manager 117 generates a payload XML and header message using the message generator 117a, and broadcasts the generated message.

Then, a device 100 connected with the home network receives the message through a socket, and a message manager 117 of the device 100 analyzes the header and the payload using a message parser 117b. When an OP code of the header is “DEVICE_DISCOVERY_REQUEST,” a discovery manager 111 of the device 100 compares the received information with its own device information.

When the device 100 corresponds to a requested device 100, the device 100 collects its own device information, generates a payload XML and header message using the message manager 117, and then transmits the DA message to the requesting device or service.

Subsequently, the device 100 receiving the DA message through a socket analyzes the header and the payload using the message parser 117b of the message manager 117, and when an OP code of the header is “DEVICE_DISCOVERY_RESPONSE,” the discovery manager 111 updates a device list/information.

The advertisement manager 113 functions to announce a change in basic status such as a connection or on/off of a device using a “DEVICE_ADVERTISEMENT” message.

The “DEVICE_ADVERTISEMENT” message notifies devices (services) on the network of basic information about the device by broadcasting the basic information when the device is initially connected to the network or turned on or off.

When the device participating in the network is an apparatus, such as a gateway, interoperating with several devices, information about devices in the node may be provided at the same time.

The “DEVICE_ADVERTISEMENT” message has a similar structure to the above-described “DEVICE_DISCOVERY_RESPONSE” message. However, AdType is added to basic information to present “Start”/“End” in the form of a string, and thus it is possible to determine whether the corresponding device currently participates in or leaves the network.

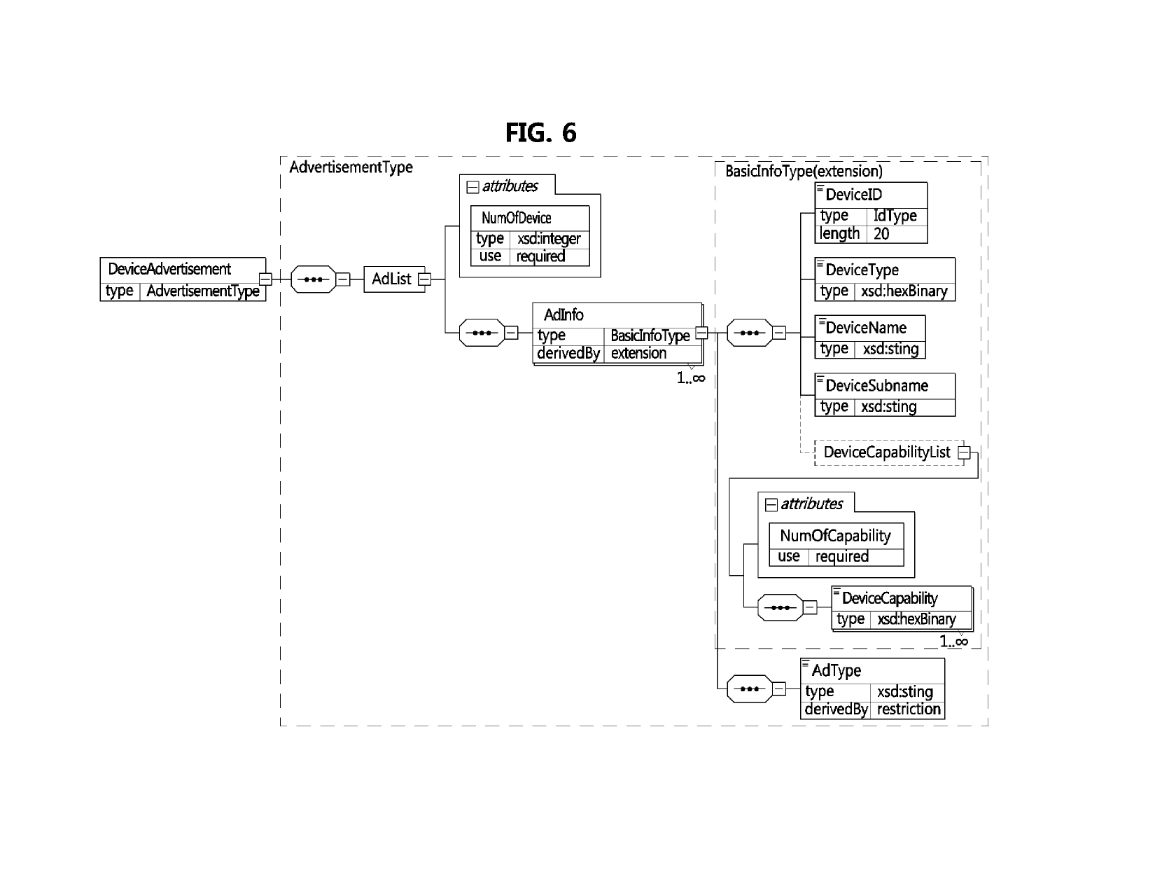

Examples of the “DEVICE_ADVERTISEMENT” message and a schema structure are shown in Table 7 and Table 8 below and FIG. 6.

TABLE 7

| OP Code | Parameter | Size | Description |
|---|---|---|---|
| Device Advertisement (0x1121) | AdList | Variable | AdList type |

TABLE 8

| Data | Parameter | | | | |
|---|---|---|---|---|---|
| Structure | (Condition) | Sub Parameter | Size | Description | Condition |
| AdList | NumOfDevice | — | 2 bytes | Integer | M |
| Type | (M) | | | | |
| | AdInfo | DeviceID | 20 bytes | Char[20] | M |
| | (M) | DeviceType | 2 bytes | Device type | M |
| | | DeviceName | 16 bytes | Char[16] | M |
| | | DeviceSubName | 16 bytes | Char[16] | M |
| | | DeviceCapabilityList | Variable | DeviceCapabilityList | O |
| | | | | type | |
| | | AdType | 16 bytes | Char[16] | M |
| | | | | Start | |
| | | | | End | |

An example of a device advertisement process will be described. When a service is initially connected to the network, or a device is turned on or off, the advertisement manager 113 of the device interoperates with the message manager 117 to generate a payload XML and header message.

When the generated message is broadcast, devices connected with the network receive the message through sockets, and message parsers 117b of message managers 117 analyze the header and the payload. When an OP code of the header is “DEVICE_ADVERTISEMENT,” the advertisement manager 113 updates information such as a device ID with the received information.

The information manager 112 functions to request and receive various pieces of information from a specific device on the home network using a “DEVICE_INFO_REQUEST” message and a “DEVICE_INFO_RESPONSE” message.

The “DEVICE_INFO_REQUEST” message is used to request various pieces of information from a specific device. Table 9 below shows an example of a structure of a payload message that should be generated with “DEVICE_INFO_REQUEST.”

A parameter used in “DEVICE_INFO_REQUEST” is one of requested device information types (DeviceInfoReqType), and the device information types may be generally classified into three types, that is, “BasicInfo,” “FunctionList,” and “DeviceProperty.”

“FullDescription” including all three types of information, and “CommonProperty,” “ConfigProperty,” “StatusProperty,” and “DeviceSpecificProperty” that are detailed items of “DeviceProperty” may also be used as device information types upon a request, and all of these may be presented in the form of a 32-byte string.

TABLE 9

| OP Code | Parameter | Size | Description | Condition |
|---|---|---|---|---|
| Device Info Request | DeviceInfoReqType | 32 bytes | Char[16] | M |
| (0x2011) | | | FullDescription | |
| | | | BasicInfo | |
| | | | FunctionList | |
| | | | DeviceProperty | |
| | | | CommonProperty | |
| | | | ConfigProperty | |
| | | | StatusProperty | |
| | | | DeviceSpecificProperty | |

“BasicInfo” is used to request basic information such as a device ID, a device type, and a device name. “FunctionList” is used to request a list of functions defined according to a device.

“DeviceProperty” is classified as “CommonProperty” denoting general information such as a device model and a version, “ConfigProperty” denoting configuration information, “StatusProperty” denoting a current status of the device, and “DeviceSpecificProperty” denoting device-specific unique properties, and it is possible to request and receive only necessary pieces of information according to a service.

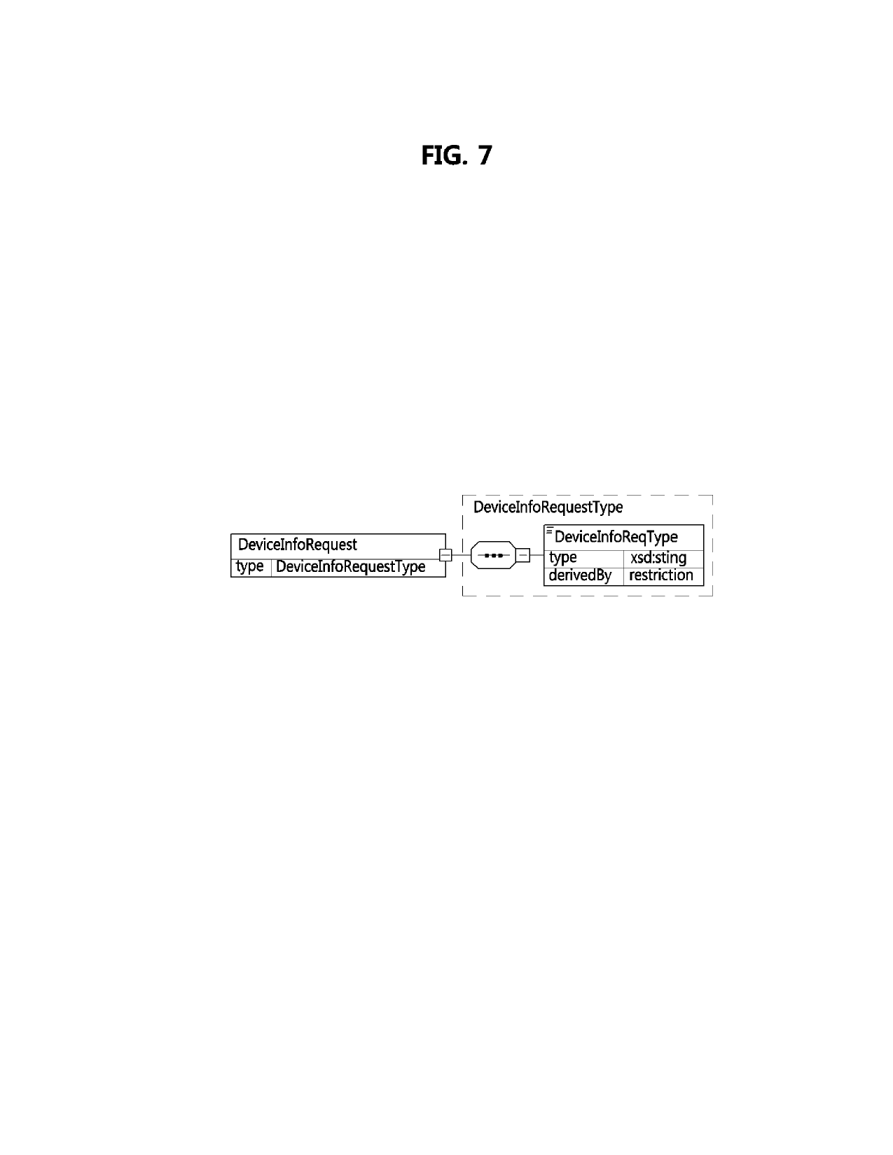

An XML schema structure of a payload message structure of the aforementioned “DEVICE_INFO_REQUEST” message may be as illustrated in FIG. 7.

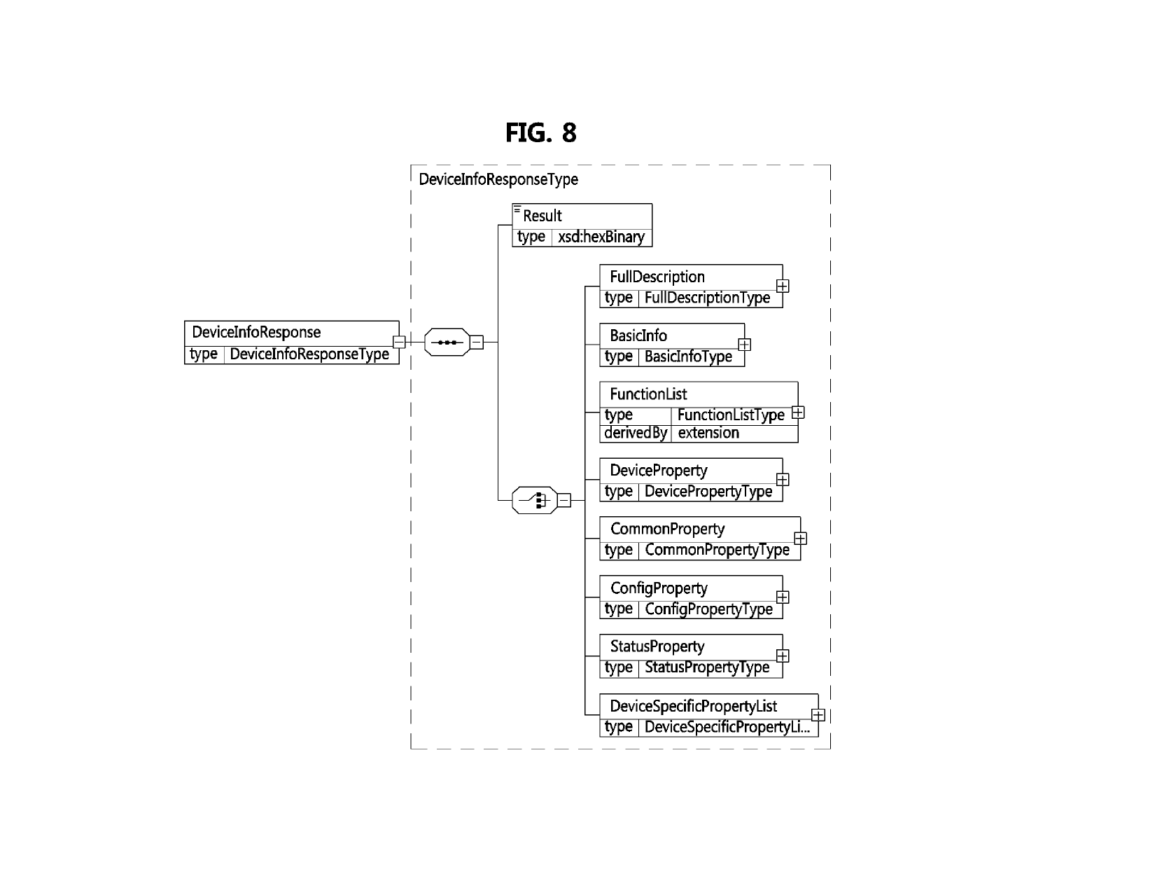

“DEVICE_INFO_RESPONSE” is a message for making a response to an information request received from a specific device with the corresponding information according to a type of the requested information. Table 10 below shows a structure of a payload message generated with “DEVICE_INFO_RESPONSE,” and type-specific message structures are shown in FIG. 8.

TABLE 10

| OP Code | Parameter | Size | Description | Condition |
|---|---|---|---|---|
| DeviceInfo | Result | 2 bytes | Error code | M |
| Response | FullDescription | Variable | BasicInfo type | — |
| (0x2012) | | | FunctionList type | |
| | | | DeviceProperty type | |
| | BasicInfo | Variable | BasicInfo type | — |
| | FunctionList | Variable | FunctionList type | — |
| | DeviceProperty | Variable | CommonProperty type | — |
| | | | ConfigProperty type | |
| | | | StatusProperty type | |
| | | | DeviceSpecificProperty type | |
| | CommonProperty | Variable | CommonProperty type | — |
| | ConfigProperty | Variable | ConfigProperty type | — |
| | StatusProperty | Variable | StatusProperty type | — |
| | DeviceSpecificProperty | Variable | DeviceSpecificProperty type | — |

Referring to Table 10, device information may be basically classified into three types, that is, “BasicInfo,” “FunctionList,” and “DeviceProperty,” and all three types of information may be sent together when a “FullDescription” request is received.

The “DeviceProperty” information may also be sent according to respective detailed items, that is, “CommonProperty,” “ConfigProperty,” “StatusProperty,” and “DeviceSpecificProperty.”

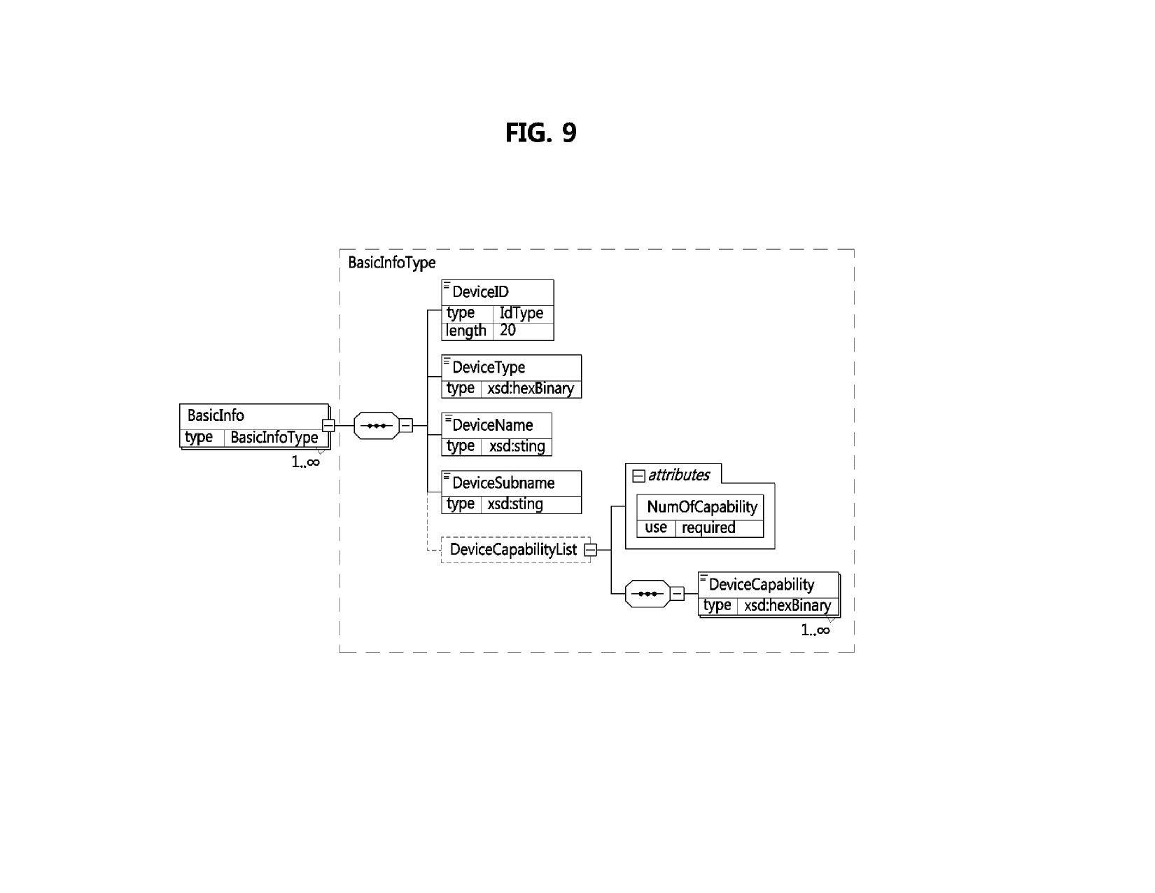

“BasicInfo” is used when a response is made with basic information such as a device ID, a device type, and a device name. In particular, “BasicInfo” includes information “DeviceCapabilityList,” which may present various unique functions supported by a complex device on the basis of existing device types when the new device type in which functions of existing devices are combined comes into the market. Table 11 below shows an example of a message structure of “BasicInfo,” and FIG. 9 shows a schema structure of the “BasicInfo” message.

TABLE 11

| Data Structure | Parameter | Size | Description | Condition |
|---|---|---|---|---|
| BasicInfo | DeviceID | 20 bytes | Char[20] | M |
| Type | DeviceType | 2 bytes | Device type | M |
| | DeviceName | 16 bytes | Char[16] | M |
| | DeviceSubName | 16 bytes | Char[16] | M |
| | DeviceCapabilityList | Variable | DeviceCapabilityList | O |
| | | | type | |
| DeviceCapabilityList | NumOfCapability | 2 bytes | Integer | M |
| Type | DeviceCapability | 2 bytes | Device type | M |

“FunctionList” relates to a list of functions defined according to the device. Table 12 below shows an example of a message structure of “FunctionList.” “NumOfFunction” denotes the number of functions provided according to a device, “FunctionID” denotes a function ID defined according to the device, and “FunctionCategory” indicates a category of a function, such as whether the function is a control function or an event function.

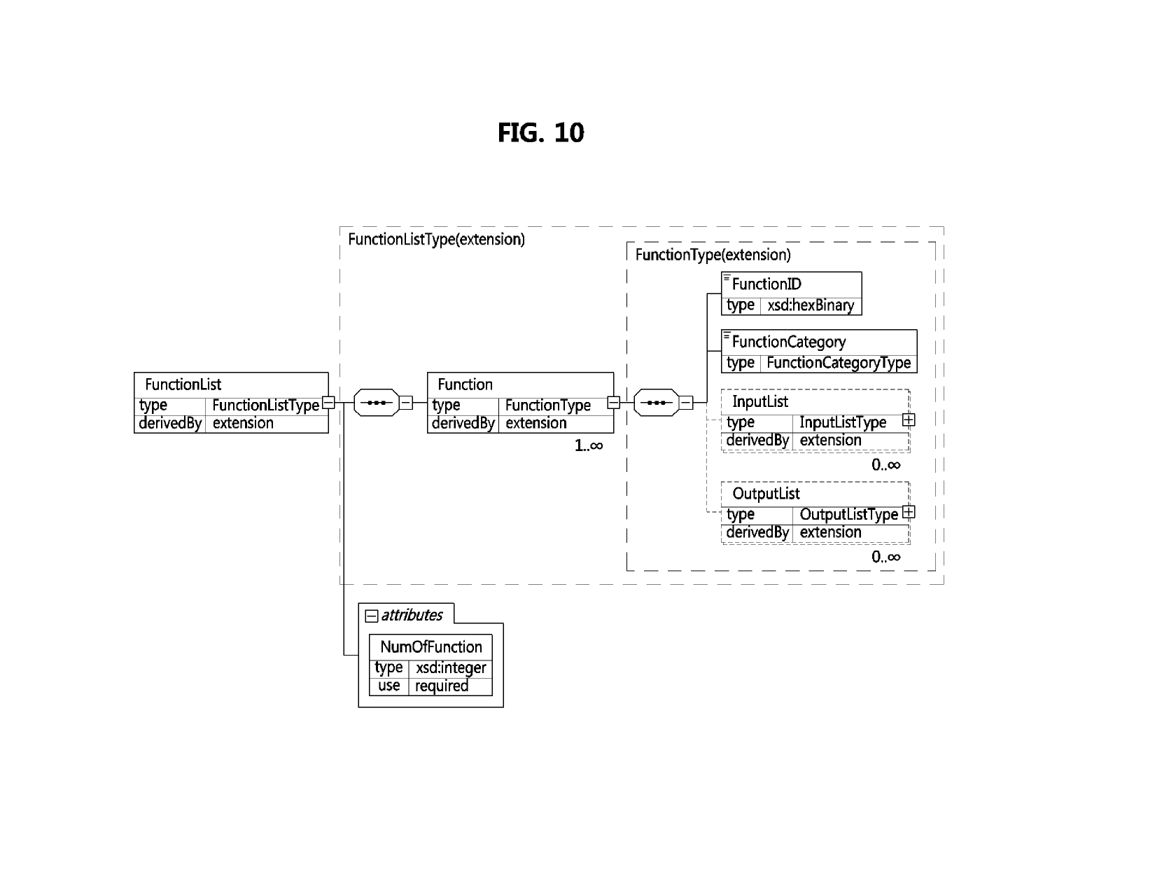

“InputList” denotes a list of messages input to the device to perform a specific function, and “OutputList” denotes a list of messages output from the device. A basic XML schema structure of the aforementioned “FunctionList” message may be as shown in FIG. 10.

TABLE 12

| | | | | Con- |
|---|---|---|---|---|
| Data Structure | Parameter | Size | Description | dition |
| FunctionList | NumOfFunction | 2 bytes | Integer | M |
| Type | FunctionID | 4 bytes | Hex | M |
| | FunctionCategory | 8 bytes | Char[8] | M |
| | | | Control | |
| | | | Event | |
| | InputList | Variable | InputList type | O |
| | OutputList | Variable | OutputList type | O |

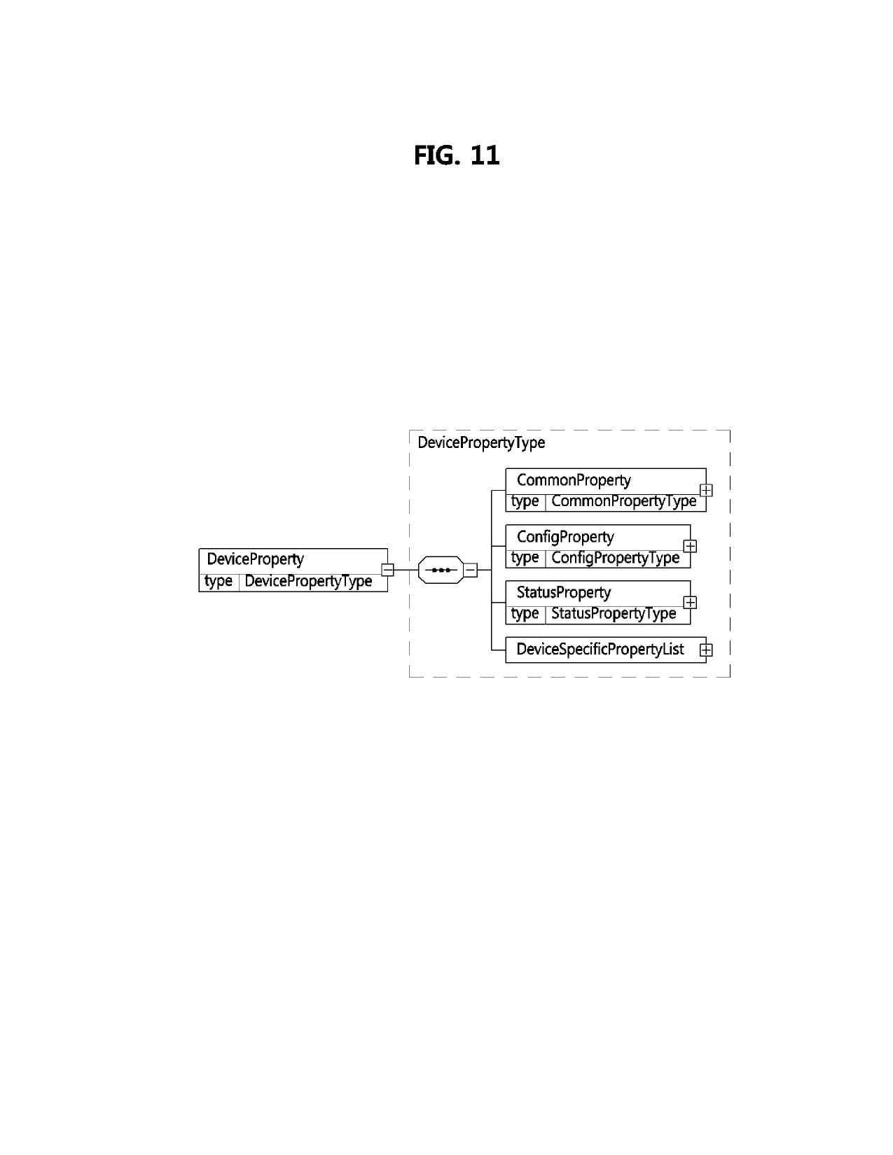

“DeviceProperty” may consist of “CommonPoperty” denoting general information such as a device model and a version, “ConfigProperty” denoting configuration information, “StatusProperty” denoting a current status of the device, and “DeviceSpecificProperty” denoting device-specific unique properties. It is possible to request and receive only necessary pieces of information according to a service. Table 13 below shows an example of a message structure of “DeviceProperty,” and FIG. 11 shows an example of a schema structure of “DeviceProperty.”

TABLE 13

| Data Structure | Parameter | Size | Description | Condition |
|---|---|---|---|---|
| DeviceProperty | CommonProperty | Variable | CommonProperty type | M |
| Type | ConfigProperty | Variable | ConfigProperty type | M |
| | StatusProperty | Variable | StatusProperty type | M |
| | DeviceSpecificProperty | Variable | DeviceSpecificProperty | M |
| | | | type | |

“ConfigProperty” presents information for a network configuration and a firmware or software configuration of the device. Particularly, in the case of a device configuration, “Configuration” file name information is presented, such that respective manufacturers can independently make settings. Here, a file transfer protocol (FTP) uniform resource locator (URL) of “DeviceConfig” is an FTP address at which file management is performed for “Configuration File,” “Apply Operation,” and so on.

An example of a device information request and response process of the information manager 112 will be described. When a service or an application selects a specific device and requests specific information, the information manager 112 interoperates with the message manager 117 to generate a payload XML and header message. The generated message is transferred to a target device ID, and the device receives the message through a socket.

Then, a message manager 117 of the device analyzes the header and the payload. When an OP code of the header is “INFORMATION_REQUEST,” an information manager 112 collects device information about the device and interoperates with the message manager 117 to generate a payload XML and header message. Subsequently, when the message is transmitted to the requesting device or service, the device receiving the message analyzes the header and the payload using the message manager 117. When an OP code of the header is “INFORMATION_RESPONSE,” the device updates device information with the received information.

The control manager 115 functions to control a device or a service using a “DEVICE_CONTROL_REQUEST” message and a “DEVICE_CONTROL_RESPONSE” message on the basis of various device-specific functions.

“DEVICE_CONTROL_REQUEST” is a request message for controlling a device or a service on the basis of various device-specific functions. Device-specific function lists may be presented in various ways according to a type of the corresponding device.

Table 14 below shows an example of a message structure of “Device Control Request.” “FunctionID” consists of a total of four bytes, of which two upper bytes are a device type code, and two lower bytes are used for function list categorization.

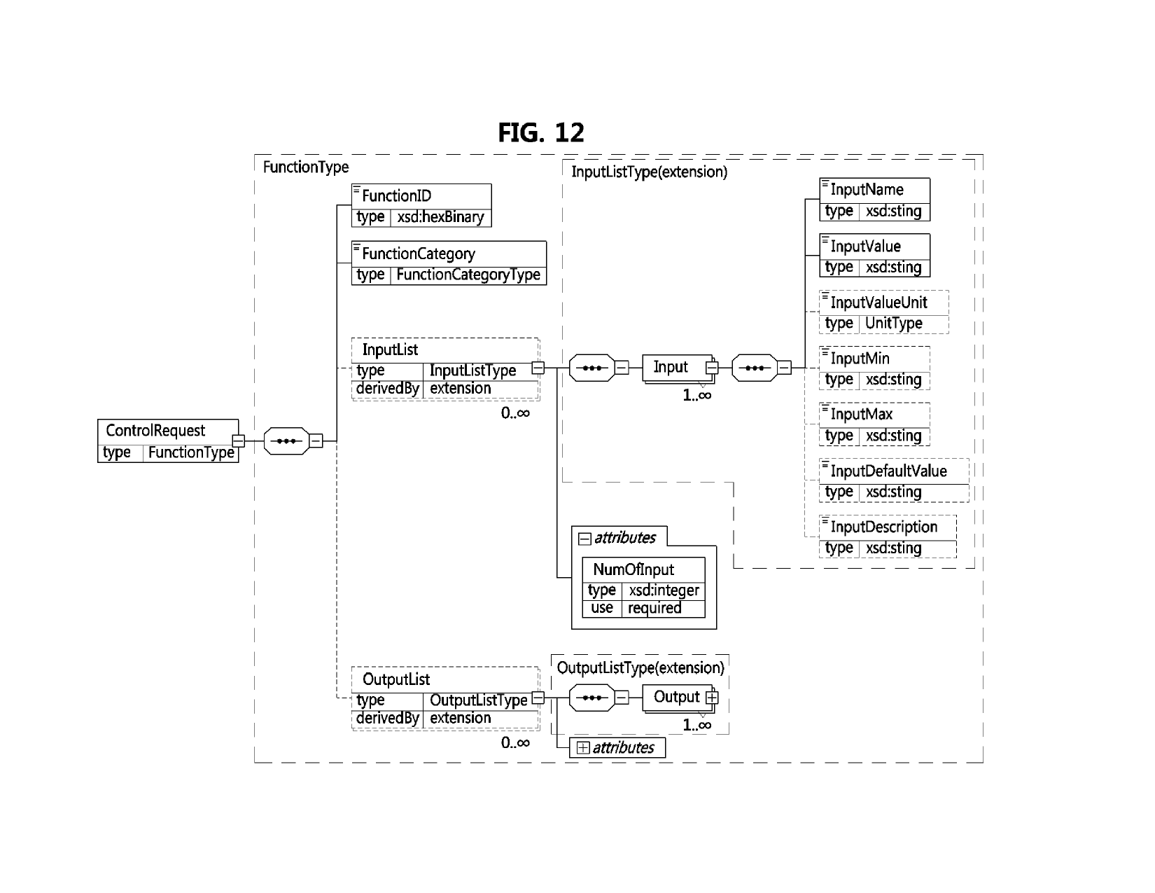

Thus, even when there is only “FunctionID,” it is possible to know how and which device is controlled. Also, “FunctionCategory” may indicate whether the corresponding message is control information or event information, and may be presented by a string type of “Control” or “Event.” An XML schema structure of a payload message structure of such “DEVICE_CONTROL_REQUEST” may be as illustrated in FIG. 12.

TABLE 14

| OP Code | Parameter | Size | Description | Condition |
|---|---|---|---|---|
| Device | FunctionID | 4 bytes | Hex | M |
| Control | FunctionCategory | 8 bytes | Char[8] | M |
| Request | | | Control | |
| (0x2111) | | | Event | |
| | InputList | Variable | InputList type | O |
| | OutputList | Variable | OutputList type | O |

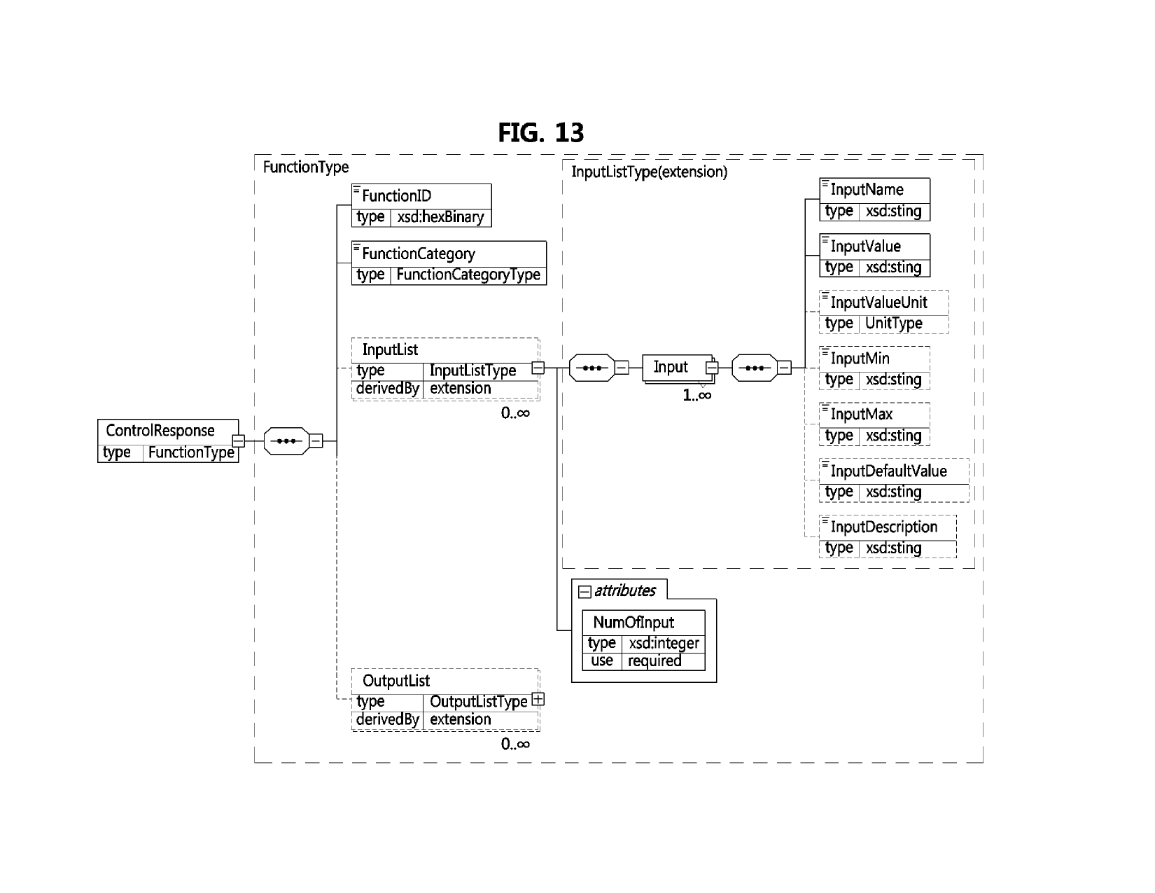

“DEVICE_CONTROL_RESPONSE” is a response message to the “DEVICE_CONTROL_REQUEST” message for performing various device-specific functions. Various response types include various pieces of information according to a service result as well as information indicating whether or not the corresponding function has been performed normally in response to the request, and may have the same basic message structure as that “DEVICE_CONTROL_REQUEST.” Table 15 below shows an example of a “DEVICE_CONTROL_RESPONSE” message structure, and an XML schema structure may be as illustrated in FIG. 13.

TABLE 15

| OP Code | Parameter | Size | Description | Condition |
|---|---|---|---|---|
| Device | FunctionID | 4 bytes | Hex | M |
| Control | FunctionCategory | 8 bytes | Char[8] | M |
| Response | | | Control | |
| (0x2112) | | | Event | |
| | InputList | Variable | InputList type | O |
| | OutputList | Variable | OutputList type | O |

An example of a device control process of the control manager 115 will be described. When a service or an application selects a specific device and requests control, the control manager 115 interoperates with the message manager 117 to generate a payload XML and header message. The generated message is transferred to a target device ID, and the target device receives the message through a socket. Then, a message manager 117 of the target device analyzes the header and the payload.

When an OP code of the header is “CONTROL_REQUEST,” a control manager 115 of the target device calls the corresponding device control module, and the device control module issues a control command, collects information necessary for a functional structure, and then interoperates with the message manager 117 to generate a payload XML and header message. Subsequently, the message is transmitted to the requesting device or service, and the message manager 117 of the device receiving the message analyzes the message. When an OP code of the header is “DEVICE_CONTROL_RESPONSE,” the control manager 115 performs an update with the received information.

The event manager 114 functions to transmit event information to a specific device having requested a subscription using, for example, “EVENT_NOTIFICATION,” “EVENT_SUBSCRIPTION_REQUEST,” and “EVENT_SUBSCRIPTION_RESPONSE” messages when an event occurs.

“EVENT_NOTIFICATION” is a message structure for a device, such as a sensor, that periodically causes a specific event, and notifies the specific device having requested a subscription of event messages. A basic structure may be in accordance with “OutputList Type” of “FunctionList Type.” Device-specific event lists may be presented in various ways according to a type of the device.

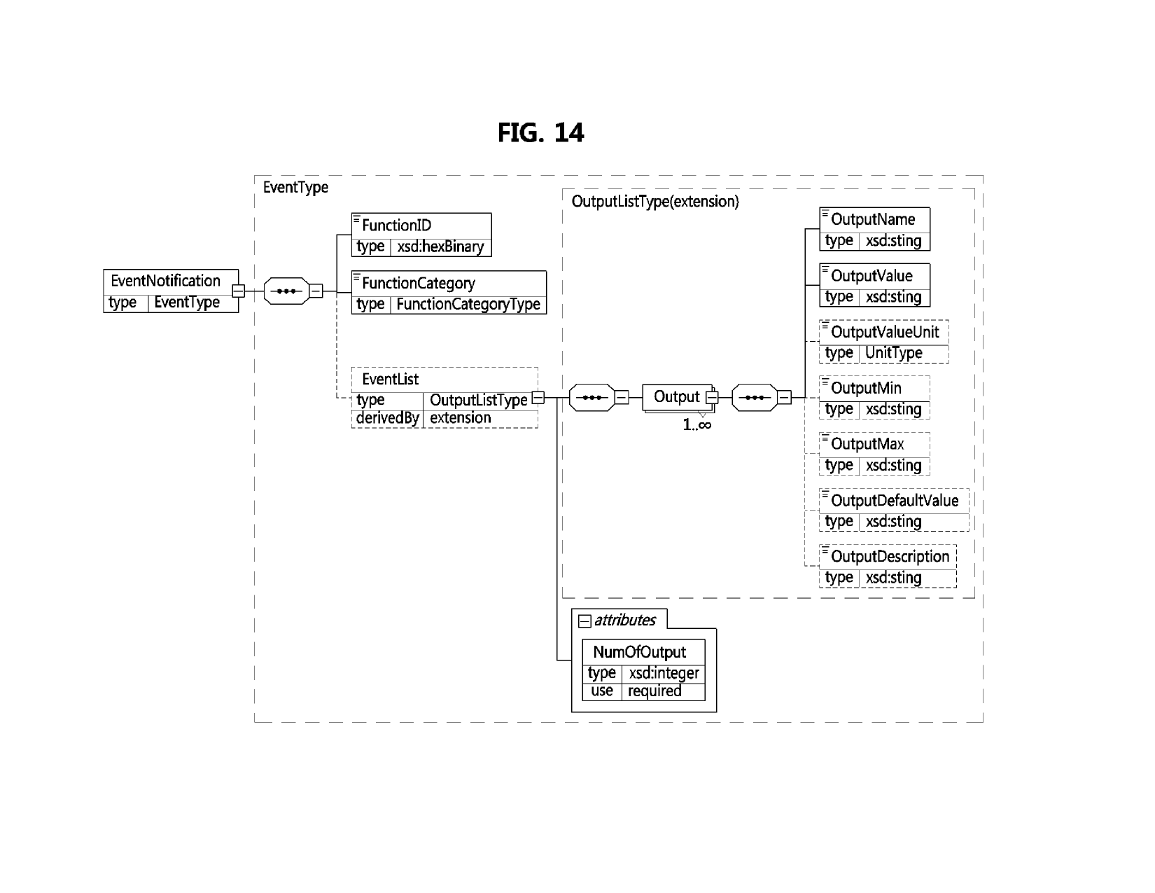

An example of a message structure of “EVENT_NOTIFICATION” is shown in Table 16 below, and an XML schema structure may be as illustrated in FIG. 14.

TABLE 16

| OP Code | Parameter | Size | Description | Condition |
|---|---|---|---|---|
| Event | FunctionID | 4 bytes | Hex | M |
| Notification | FunctionCategory | 8 bytes | Char[8] | M |
| (0x2FF1) | | | Control | |
| | | | Event | |
| | EventList | Variable | OutputList type | O |

An example of an event notification process of the event manager 114 will be described. To transmit an event message to a device from which a subscription request has been received, the event manager 114 interoperates with the message manager 117 to generate a payload XML and header message about the corresponding information, and transfer the generated message to a target device ID. Then, a message manager 117 of the target device analyzes the header and the payload. When an OP code of the header is “EVENT_NOTIFICATION,” an event manager 114 analyzes the received information and applies it to the corresponding application.

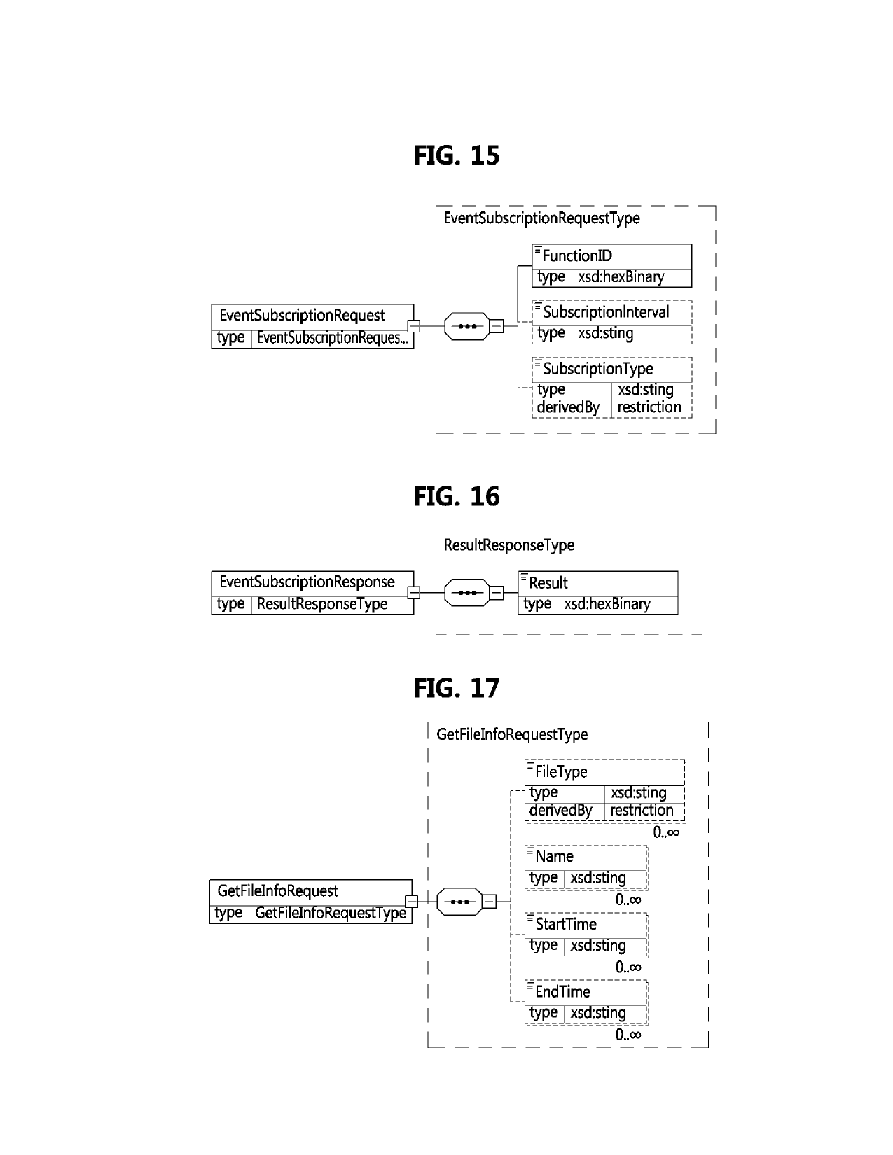

“EVENT_SUBSCRIPTION_REQUEST” is a request message for a device, such as a sensor, that periodically causes a specific event to subscribe to event information. An example of an “EVENT_SUBSCRIPTION_REQUEST” message structure is shown in Table 17 below, and an XML schema structure may be as illustrated in FIG. 15.

“SubscriptionInterval” is period information about information to which a subscription will be made, and presented in units of ms. Also, “SubscriptionType” is information indicating that a currently registered event is new registration, update, or cancellation, and may be presented as a string type of “Renew,” “Registration” or “Cancel”.

TABLE 17

| OP Code | Parameter | Size | Description | Condition |
|---|---|---|---|---|
| Event | FunctionID | 4 bytes | Hex | M |
| Subscription | SubscriptionInterval | 8 bytes | Char[8] | O |
| Request | | | (ms) | |
| (0x2F11) | SubscriptionType | 8 bytes | Char[16] | O |
| | | | Renew | |
| | | | Registration | |
| | | | Cancel | |

“EVENT_SUBSCRIPTION_RESPONSE” is a response message to a request for subscribing to specific event information such as sensing information. The message may be presented by “Result Code” shown in Table 18 below, and a schema structure may be as illustrated in FIG. 16.

TABLE 18

| OP Code | Parameter | Size | Description | Condition |
|---|---|---|---|---|
| Event Subscription | Result | 2 bytes | Result Code | M |
| Response (0x2F12) | | | | |

An example of an event subscription request and response process of the event manager 114 will be described. When a service or an application issues a specific event subscription command, the event manager 114 interoperates with the message manager 117 to generate a payload XML and header message. The generated message is transferred to a target device ID, and a message manager 117 of the receiving device analyzes the message. When an OP code of the header is “EVENT_SUBSCRIPTION,” the message manager 117 analyzes the received information and updates an event manager 114 of the device.

In this process, the event manager 114 interoperates with the message manager 117 to generate a payload XML and header message about result information. The generated message is transmitted to the requesting device or service, and the message manager 117 of the device receiving the message analyzes the message. When an OP code of the header is “EVENT_SUBSCRIPTION_RESPONSE,” the event manager 114 receives a result information value, thereby finishing the event subscription request and response process.

The file manager 116 functions to perform file transmission and reception and a function for a specific file, and manage the result of the file transmission and reception and the result of the function for the specific file using, for example, “GET_FILEINFO_REQUEST,” “GET_FILEINFO_RESPONSE,” “GET_FILE_REQUEST,” “GET_FILE_RESPONSE,” “GET_FILE_RESULT,” “PUT_FILE_REQUEST,” “PUT_FILE_RESPONSE,” “PUT_FILE_RESULT,” “APPLY_REQUEST,” “APPLY_RESPONSE,” and “APPLY_RESULT” messages.

“GET_FILEINFO_REQUEST” is a message for requesting file information necessary for a file transmission and reception process. Examples of the “GET_FILEINFO_REQUEST” message and a schema structure are shown in Table 19 below and FIG. 17.

Parameters for an information request are a file type, a file name, a search start time, and a search end time, and file information may be requested on a condition of various file types, such as a log file, an execution file, a firmware file, and a configuration file.

TABLE 19

| OP Code | Parameter | Size | Description | Condition |
|---|---|---|---|---|
| Get Fileinfo | FileType | 16 | Char[16] | O |
| Request | | bytes | All | |
| (0x2211) | | | Log | |
| | | | Execution | |
| | | | Firmware | |
| | | | Debug | |
| | | | Configure | |
| | | | Image | |
| | | | Audio | |
| | | | Video | |
| | | | Text | |
| | Name | 64 | Char[64] | O |
| | | bytes | | |
| | StartTime | 16 | Char[16] | O |
| | | bytes | Year, month, day, hour, | |
| | | | minute, and second | |
| | | | (e.g. 20110808242233) | |
| | EndTime | 16 | Char[16] | O |
| | | bytes | Year, month, day, hour, | |
| | | | minute, and second | |
| | | | (e.g. 20110808242233) | |

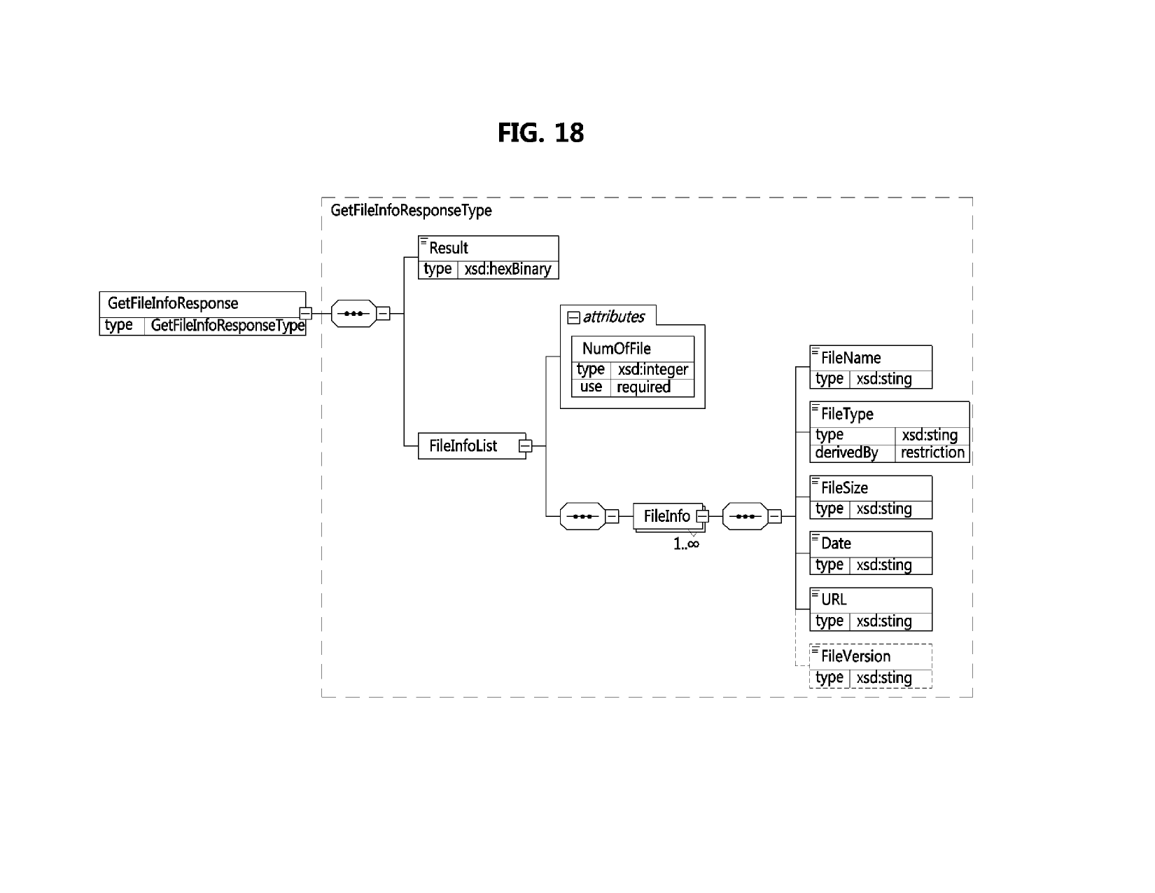

“GET_FILEINFO_RESPONSE” is a response message to the file information request. In this message, a file information list complying with a requested file condition, and file information may include a file name, a file type, a file size, a file creation date, a file URL, and file version information. Examples of the “GET_FILEINFO_RESPONSE” message and a schema structure are shown in Table 20 and Table 21 below, and FIG. 18.

TABLE 20

| OP Code | Parameter | Size | Description | Condition |
|---|---|---|---|---|
| Get Fileinfo | Result | 2 bytes | Result code | M |
| Response | FileInfoList | Variable | (Table 5) | M |
| (0x2212) | | | FileInfoList type | |

TABLE 21

| Data | Parameter | Sub | | | |
|---|---|---|---|---|---|
| Structure | (Condition) | Parameter | Size | Description | Condition |
| FileInfoList | NumOfFile | — | 2 bytes | Integer | M |
| Type | (M) | | | | |
| | FileInfo (M) | FileName | 64 bytes | Char[64] | M |
| | | FileType | 16 bytes | Char[16] | M |
| | | | | All | |
| | | | | Log | |
| | | | | Execution | |
| | | | | Firmware | |
| | | | | Debug | |
| | | | | Configure | |
| | | | | Image | |
| | | | | Audio | |
| | | | | Video | |
| | | | | Text | |
| | | FileSize | 8 bytes | Char[8] | M |
| | | | | (M bytes) | |
| | | Date | 16 bytes | Char[16] | M |
| | | | | Year, month, day, hour, | |
| | | | | minute, and second | |
| | | | | (e.g. 20110808242233) | |
| | | URL | 256 bytes | Char[256] | M |
| | | | | (FTP URL) | |
| | | FileVersion | 16 bytes | Char[16] | O |

An example of a file information request and response process of the file manager 116 will be described. When a service or an application requests file information about a target device, the file manager 116 interoperates with the message manager 117 to generate a payload XML and header message.

When the generated message is transferred to a target device ID, the device receives the message, and a message manager 117 analyzes the message. When an OP code of the header is “GET_FILEINFO_REQUEST,” a file manager 116 analyzes the received information, collects information for response, and then interoperates with the message manager 117 to generate a message.

The message is transmitted to the requesting device or service, and the message manager 117 of the device receiving the message analyzes the message. When an OP code of the header is “GET_FILEINFO_RESPONSE,” the file manager 116 receives file information and manages the target device.

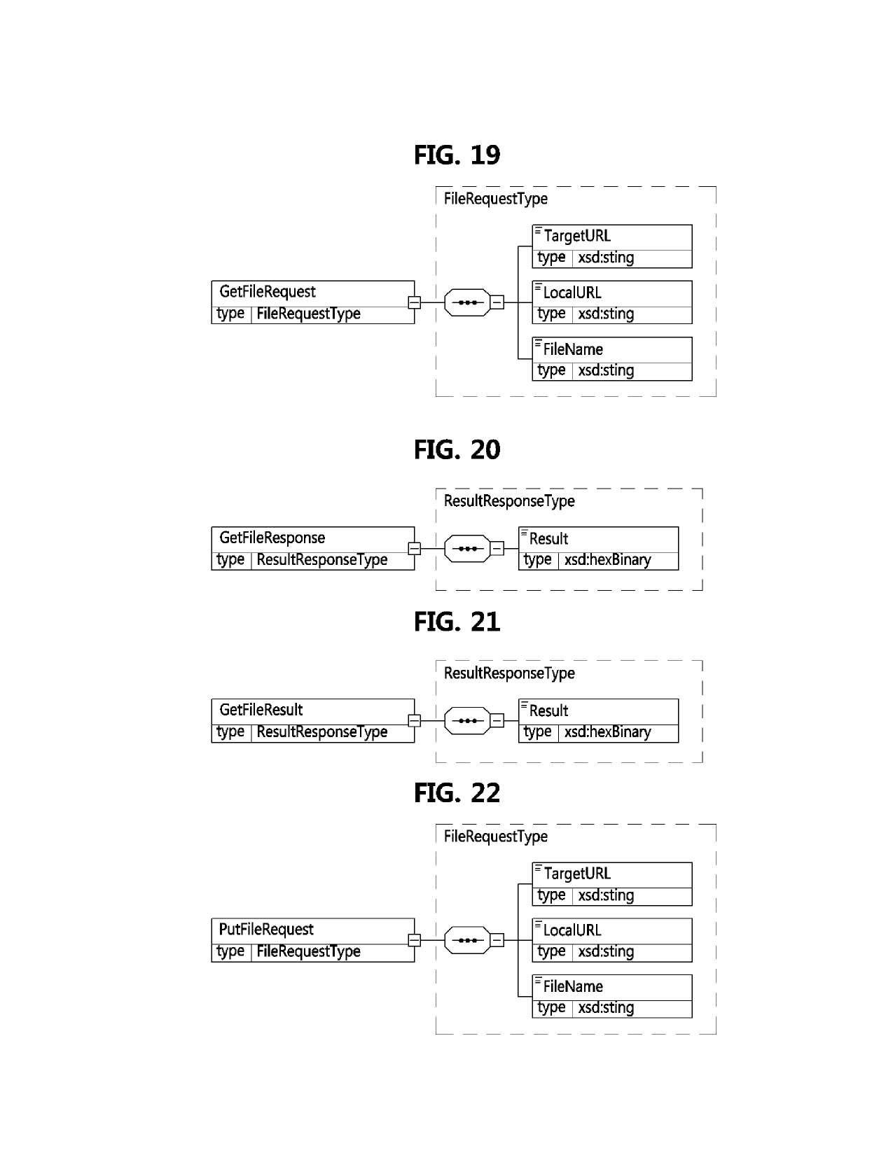

“GET_FILE_REQUEST” is a message for a file transmission request. This message presents a position of a target device and a position of the local device using URLs, and may also present a file name together. Actual file download may be performed through FTP in a peer-to-peer fashion. Examples of the “GET_FILE_REQUEST” message and a schema structure are shown in Table 22 below and FIG. 19.

TABLE 22

| OP Code | Parameter | Size | Description | Condition |
|---|---|---|---|---|
| Get File Request | TargetURL | 256 bytes | Char[256] | M |
| (0x2221) | | | (FTP) | |
| | LocalURL | 256 bytes | Char[256] | M |
| | | | (FTP) | |
| | FileName | 256 bytes | Char[256] | M |

“GET_FILE_RESPONSE” is a response message to the file transmission request, and may present an error code. Examples of the “GET_FILE_RESPONSE” message and a schema structure are shown in Table 23 below and FIG. 20.

TABLE 23

| OP Code | Parameter | Size | Description | Condition |
|---|---|---|---|---|
| Get File Response | Result | 2 bytes | Error code | M |
| (0x2222) | | | | |

It may take much time for actual file transmission to be completely performed by “GET_FILE_REQUEST.” Thus, when operation for the file transmission request is started, the aforementioned “Get File Response” message is generated as a response message, and a response message about a transmission error, a transmission end, etc. occurring in an actual file transmission process is generated as “GET_FILE_RESULT.” Examples of the “GET_FILE_RESULT” message and a schema structure are shown in Table 24 below and FIG. 21.

TABLE 24

| OP Code | Parameter | Size | Description | Condition |
|---|---|---|---|---|
| Get File Result | Result | 2 bytes | Error code | M |
| (0x2223) | | | | |

An example of a file transmission process of the file manager 116 will be described. When a service or an application requests file transmission from a target device, the file manager 116 interoperates with the message manager 117 to generate a payload XML and header message. The generated message is transferred to a target device ID, and a message manager 117 of the device analyzes the message.

When an OP code of the header is “GET_FILE_REQUEST,” a file manager 116 analyzes the received information and issues a file transmission command to the corresponding address using FTP. Subsequently, when FTP transmission is started or fails, the file manager 116 interoperates with the message manager 117 to generate an error message and transmits the message to the requesting device or service.

The message manager 117 of the device receiving the message analyzes the message. When an OP code of the header is “GET_FILE_RESPONSE,” the file manager 116 receives result information and manages “Get File Transaction.”

When the service or the device performing file transmission finishes FTP file transmission, or an error occurs during FTP file transmission, the file manager 116 interoperates with the message manager 117 to generate an FTP error message and transmits the message to the requesting device or the requesting service. The message manager 117 of the device receiving the message analyzes the message. When an OP code of the header is “GET_FILE_RESULT,” the file manager 116 receives a result value and manages “Get File Transaction.”

“PUT_FILE_REQUEST” is a message for requesting file transfer to a specific URL. This message presents a position of a target device and a position of the local device using URLs, and may also present a file name together. Actual file download may be performed through FTP in a peer-to-peer fashion.

Examples of the “PUT_FILE_REQUEST” message and a schema structure are shown in Table 25 below and FIG. 22.

TABLE 25

| OP Code | Parameter | Size | Description | Condition |
|---|---|---|---|---|
| Put File Request | TargetURL | 256 bytes | Char[256] | M |
| (0x2231) | | | (FTP) | |
| | LocalURL | 256 bytes | Char[256] | M |
| | | | (FTP) | |
| | FileName | 256 bytes | Char[256] | M |

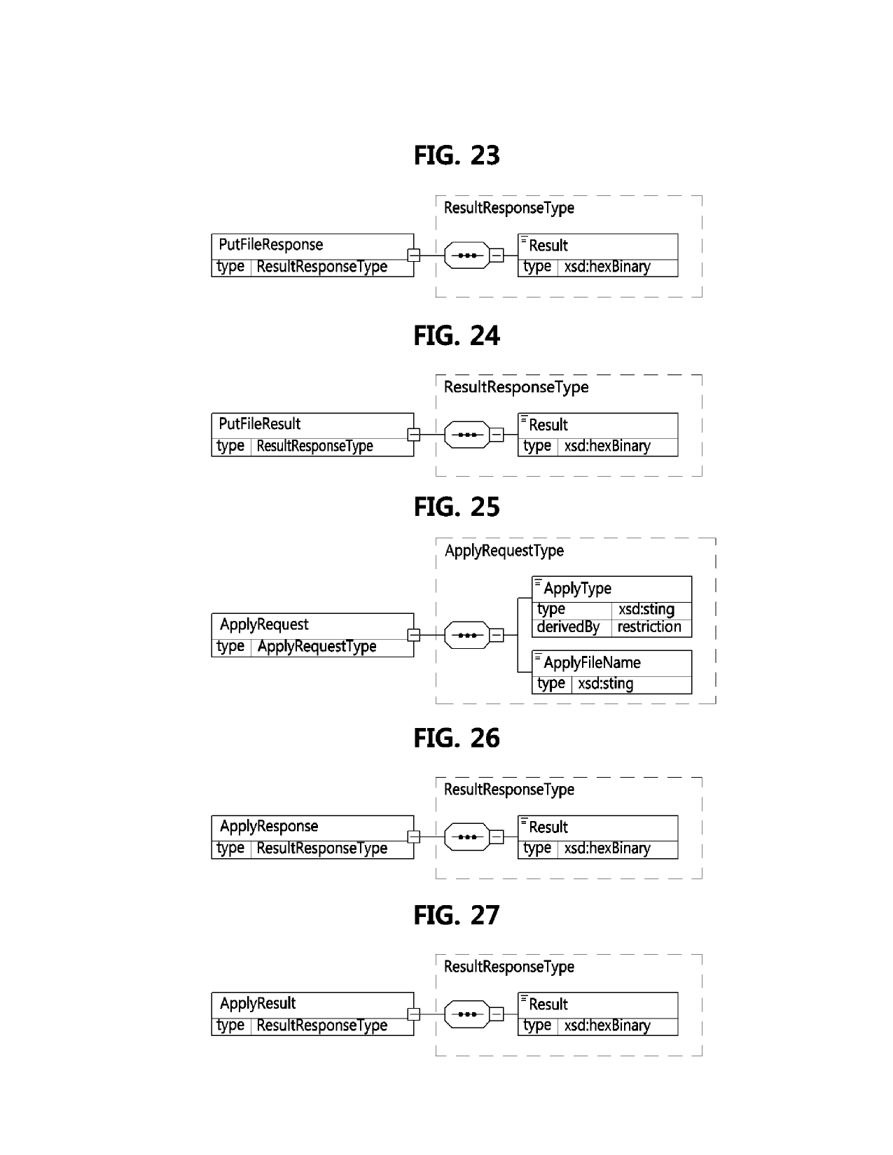

“PUT_FILE_RESPONSE” is a response message to the file transfer request, and may be presented by an error code. Examples of the “PUT_FILE_RESPONSE” message and a schema structure are shown in Table 26 below and FIG. 23.

TABLE 26

| OP Code | Parameter | Size | Description | Condition |
|---|---|---|---|---|
| Put File Response | Result | 2 bytes | Error code | M |
| (0x2232) | | | | |

It may take much time for actual file transmission to be completely performed by “PUT_FILE_REQUEST.” Thus, when an operation of the file transmission request is started, the aforementioned “Put File Response” message is generated as a response message, and a response message about a transmission error, a transmission end, etc. occurring in an actual file transmission process is generated as “PUT_FILE_RESULT.” Examples of the “PUT_FILE_RESULT” message and a schema structure are shown in Table 27 below and FIG. 24.

TABLE 27

| OP Code | Parameter | Size | Description | Condition |
|---|---|---|---|---|
| Put File Result | Result | 2 bytes | Error code | M |
| (0x2233) | | | | |

An overall process in which the file manager 116 requests file transmission to a specific URL is similar to the above-described file transmission process except that “PUT_FILE_REQUEST,” “PUT_FILE_RESPONSE,” and “PUT_FILE_RESULT” messages are used.

“APPLY_REQUEST” is a message that requests performance of functions, such as execution of a specific file, service update, rollback, file addition, and file deletion, and a function to be performed is indicated by “ApplyType.” “ApplyFileName” denotes a name of a file that provides a function to be currently performed. Examples of the “Apply Request” message and a schema structure are shown in Table 28 below and FIG. 25.

TABLE 28

| OP Code | Parameter | Size | Description | Condition |
|---|---|---|---|---|
| Apply Request | ApplyType | 16 bytes | Char[16] | M |
| (0x2311) | | | Execution | |
| | | | Update | |
| | | | Rollback | |
| | | | FileAdd | |
| | | | FileDelete | |
| | ApplyFileName | 256 bytes | Char[256] | M |

“APPLY_RESPONSE” is a response message to an “APPLY” request, and may be presented by an error code. Examples of the “Apply Response” message and a schema structure are shown in Table 29 below and FIG. 26.

TABLE 29

| OP Code | Parameter | Size | Description | Condition |
|---|---|---|---|---|
| Apply Response | Result | 2 bytes | Error code | M |
| (0x2312) | | | | |

It may take much time for an actual file function to be completely performed by “APPLY_REQUEST.” Thus, when an operation of the file function performance request is started, the aforementioned “APPLY_RESPONSE” message is generated as a response message, and a response message about an error, a function performance end, etc. occurring in an actual file function performance process is generated as “APPLY_RESULT.” Examples of the “APPLY_RESULT” message and a schema structure are shown in Table 30 below and FIG. 27.

TABLE 30

| OP Code | Parameter | Size | Description | Condition |
|---|---|---|---|---|
| Apply Result | Result | 2 bytes | Error code | M |
| (0x2313) | | | | |

An example of a process in which the file manager 116 requests performance of a function for a specific file will be described. When a service or an application requests an apply command to a target device, the file manager 116 interoperates with the message manager 117 to generate a payload XML and header message. The generated message is transferred to a target device ID, and the header and the payload of the received message are analyzed.

When an OP code of the header is “APPLY_REQUEST,” a file manager 116 analyzes the received information and issues a command to perform the corresponding operation (file execution, update, rollback, file deletion, file addition, etc.). Subsequently, when an error occurs, the file manager 116 interoperates with the message manager 117 to generate an error message. The message is transmitted back to the requesting device or service, and the device or service receiving the message analyzes the message using the message manager 117.

On the other hand, when the OP code of the header is “APPLY_RESPONSE,” the file manager 116 receives the corresponding information and manages an apply operation. When the apply operation is finished, or an error occurs during the apply operation, an error message may be generated and transmitted to the requesting device or the requesting service.

The maintenance manager 118 functions to manage remote maintenance of a device. Specifically, the maintenance manager 118 provides a firmware update function, a configuration function, a file up/download function, a rollback/reboot function, and other functions for remote maintenance.

These maintenance functions may be remotely and freely performed without an additional software installation process. In other words, for devices that use a protocol provided by a DA system according to example embodiments of the present invention, a device manufacturer can freely implement a protocol-based management function at an application level/OS level, and maintenance functions can be remotely used through the protocol of the devices without additionally installing management software on the devices.

The maintenance manager 118 is prepared in a DA module 110 of each device 100 and the DA module 210 of the information provision server 200, such that the DA module 210 of the information provision server 200 can manage maintenance of each device 100, or the DA module 110 of a specific device can manage maintenance of another device.

Using the above-described DA according to example embodiments of the present invention, a variety of service models can be created. For example, the DA enables information exchange between various devices in a home network and remote control of the devices.

Thus, the DA can be used in a guide and information provision service for buildings, historical sites, objects, and so on. When a user visits an art gallery, authenticates the user's device, for example, a smart terminal, and then connects to an AP, the user's smart terminal automatically exchanges information about terminals (e.g., OSs, platforms, and versions) with an art gallery management application service (i.e., an information provision application service module of an information provision server).

After that, an information provision application that can be used in the art gallery is automatically installed on the user's smart terminal according to a platform of the smart terminal. Then, the information provision application of the smart terminal periodically transmits position information to the art gallery management application service, and the art gallery management application service manages the position information according to a user terminal ID.

Subsequently, when a sensing means (e.g., a human body sensor or a wired/wireless sensor switch) in front of an artwork senses the user, the sensing means causes an event in the art gallery management application service, and the art gallery management application service may search for the device ID of the smart terminal at the position and display optional information about the artwork on the smart terminal.

In the above-described information providing service process, operation of the respective parts of the DA will be described in detail below.

First, when the user visits the art gallery, initially authenticates the smart terminal, and then connects to an AP 10, the advertisement manager 113 of the DA module 110 of the smart terminal collects basic information about the user's smart terminal and then transfers the collected information to the message manager 117.

After that, the message generator 117a generates a message in the form of a message structure shown in FIG. 6, and notifies the connected network of the basic information. Then, the art gallery management application service may call the information manager 112 of the DA module 110 and request property information about the user's smart terminal. Here, the property information request may be generated in the form shown in FIG. 7 by a message generator 117a and transferred.

After receiving the message from the art gallery management application service, the user's smart terminal checks that the property information request has been received using the message parser 117b, and calls the information manager 112 to collect necessary information such as terminal information (e.g., an OS, a platform, and a version).

After that, the collected information is transferred to the message generator 117a to generate a message having a structure as shown in FIG. 8, and then the generated message is transmitted to the art gallery management application service. The art gallery management application service analyzes the content transferred from the user's smart terminal using a message parser 117b, and transfers an appropriate information provision application program for the user's smart terminal using a file transmission function of a file manager 116. When file transmission is finished, the information provision application program is installed and run by an apply function of the file manager 116.

This entire process is performed on the basis of messages. A message format generated for file transmission by the message generator 117a is shown in FIG. 22, and that for file installation and running is shown in FIG. 25.

When the information provision application program is installed on the user's smart terminal, the user's smart terminal transfers its own position information to the event manager 114, and the event manager 114 interoperates with the message generator 117a to generate a message in the form shown in FIG. 14 and then transfers the generated message to the art gallery management application service.

After that, the art gallery management application service receives the position information about the user's smart terminal as an event, and also receives an event of the sensing means 20 in front of an artwork. When the user is sensed by the sensing means 20 in front of the artwork, and this event is transferred to the art gallery management application service through the aforementioned process, the art gallery management application service may make a comparison with a position of the managed smart terminal of the user, and provide optional information to the user's smart terminal through the installed information provision application program.

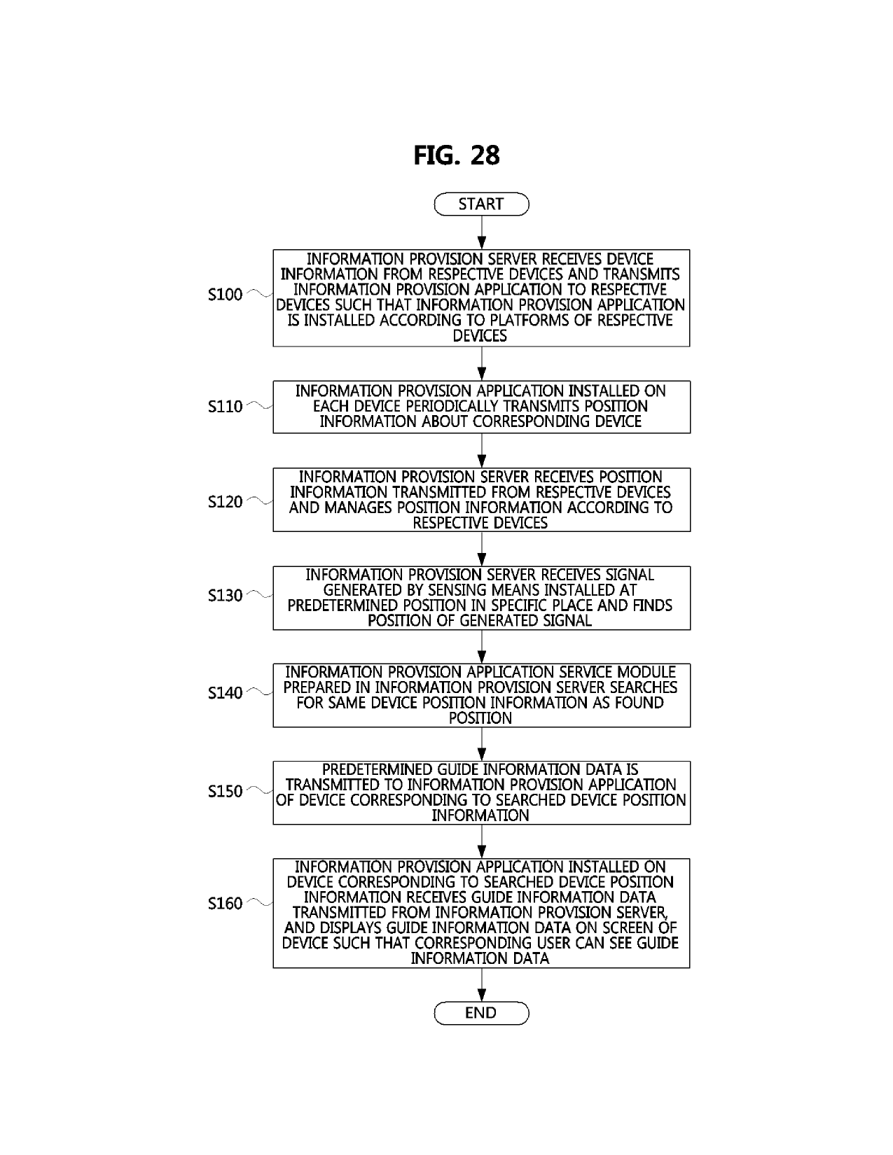

FIG. 28 is an overall flowchart illustrating an information providing service method based on an inter-device information exchange protocol according to an example embodiment of the present invention.

Referring to FIG. 1 and FIG. 28, first, the information provision server 200 receives device information from the respective devices 100, and transmits the information provision application 120 to the respective devices 100 such that the information provision application 120 can be installed according to platforms of the respective devices 100 (S100).

At this time, each of the devices 100 may perform device authentication through the information provision server 200, and then may automatically transmit its own device information to the information provision server 200 when the device connects to the wired/wireless AP 10 prepared on a wired/wireless network.

After that, the information provision application 120 installed on each of the devices 100 periodically transmits position information about the device (S110), and then the information provision server 200 receives position information transmitted from the respective devices 100 and manages the position information according to the respective devices 100 (S 120).

Subsequently, the information provision server 200 receives a signal generated by the sensing means 20 installed at a predetermined position in a specific place (e.g., an art gallery, a museum, or an exhibition hall) and finds a position of the generated signal (S130).

Next, the information provision application service module 220 prepared in the information provision server 200 searches for the same device position information as the position found in step S130 (S 140), and then transmits predetermined guide information data to the information provision application 120 of a device 100 corresponding to the device position information searched in step S140 (S150).

Finally, the information provision application 120 of the device 100 receives the guide information data transmitted from the information provision server 200 and displays the data on a screen of the device such that the corresponding user can see the data (S 160).

The above-described information providing service system and method based on an inter-device information exchange protocol according to example embodiments of the present invention synthetically use and manage information provided from several layers, such as a network layer and a service layer, as well as a device layer on the basis of the standardized protocol in a home network environment, thereby performing device control, management, automatic configuration, and other functions.

In addition, the present invention can contribute to utilization of various pieces of information about a device, and creation of new services that use a device control function, and a function of installing and running a specific application program.

Furthermore, in the present invention, information of various companies connected with a home network is expected to provide an efficient management system among all devices. Also, the present invention is expected to expand the intelligent home market, and create a new occupational cluster such as intelligent home maintenance service providers. Further, the present invention can provide an environment in which manufacturers can independently develop information home appliances.

While example embodiments of an information providing service system and method based on an inter-device information exchange protocol according to the present invention and their advantages have been described in detail, it should be understood that various changes, substitutions and alterations may be made herein without departing from the scope of the invention.

What is claimed is:

1. An information providing service system based on an inter-device information exchange protocol, comprising:
a plurality of devices on which a device architecture (DA) module and an information provision application for performing information exchange and remote control in a specific network on the basis of the standardized information exchange protocol are installed; and
an information provision server configured to receive position information periodically transmitted by the information provision application of the respective devices, manage the position information according to the respective devices, receive a signal generated by a sensing means installed at a predetermined position in a specific place, find a position of the generated signal, search for the same device position information as the found position using an information provision application service module, and transmit predetermined guide information data to the information provision application of a device corresponding to the searched device position information.

2. The information providing service system of claim 1, wherein the information provision server receives device information from the respective devices, and transmits the information provision application to the respective devices such that the information provision application is installed according to platforms of the respective devices.

3. The information providing service system of claim 2, wherein each of the devices performs device authentication through the information provision server, and then automatically transmits its own device information to the information provision server when the device connects to a wired/wireless access point (AP) prepared on the network.

4. The information providing service system of claim 1, wherein the sensing means is a human body sensor or a wired/wireless sensor switch.

5. The information providing service system of claim 1, wherein, in the specific place, a guide and information provision service for at least one of a building, a historical site and an object is provided.

6. The information providing service system of claim 1, wherein the information provision application installed on the device corresponding to the searched device position information receives the guide information data transmitted from the information provision server and displays the guide information data on a screen such that the corresponding user can see the guide information data.

7. The information providing service system of claim 1, wherein the DA module installed on each of the devices includes:
an advertisement manager configured to announce a status change of the device on the network;
an event manager configured to transmit event information to a specific device having requested a subscription when a specific event occurs on the network;
a file manager configured to perform file transmission and reception and a function for a specific file, and manage a result of the file transmission and reception and a result of the function for the specific file; and
a message manager configured to generate a message and analyze a message.

8. The information providing service system of claim 7, wherein the DA module further includes:
a discovery manager configured to search for the specific device on the network;
an information manager configured to request and receive information from the specific device on the network; and
a control manager configured to control a device or a service using various device-specific functions.

9. The information providing service system of claim 7, wherein the message manager includes:
a message generator configured to generate the message; and
a message parser configured to analyze the message, and
the messages include a header and a payload.

10. The information providing service system of claim 9, wherein the header includes a start signal, a source device identifier (ID), a target device ID, an operation (OP) code, and an end signal.

11. The information providing service system of claim 8, wherein the discovery manager uses a device discovery request message including at least one parameter among a device identifier (ID) or name, and a device type or capability parameter as a device discovery condition, and a device discovery response message in which information about a device satisfying the condition is generated as a payload.

12. The information providing service system of claim 7, wherein the advertisement manager uses a device advertisement message including at least one parameter among a number of the devices, a device identifier (ID) or name, a device type or capability, and a network participation information parameter.

13. The information providing service system of claim 8, wherein the information manager uses a device information request message including a type parameter of the device information, and a device information response message for, when information is requested by a specific device, responding with the information according to a type of the requested information.

14. The information providing service system of claim 13, wherein the device information type parameter includes at least one piece of information among basic information about the device, device-specific function list information, device property information, common property information about the device, configuration information about the device, status information about the device, and device-specific unique property information.

15. An information providing service method based on an inter-device information exchange protocol using a system including a plurality of devices on which a device architecture (DA) module and an information provision application for performing information exchange and remote control in a specific network on the basis of the standardized information exchange protocol are installed, and an information provision server, the method comprising:
(a) periodically transmitting, at the information provision application installed on the respective devices, position information about the respective devices;
(b) receiving, at the information provision server, the position information transmitted from the respective devices and managing the position information according to the respective devices;
(c) receiving, at the information provision server, a signal generated by a sensing means installed at a predetermined position in a specific place and finding a position of the generated signal;
(d) searching for, at an information provision application service module prepared in the information provision server, the same device position information as the position found in (c); and
(e) transmitting predetermined guide information data to the information provision application of a device corresponding to the device position information searched in (d).

16. The information providing service method of claim 15, further comprising, before (a), receiving, at the information provision server, device information from the respective devices and transmitting the information provision application to the respective devices such that the information provision application is installed according to platforms of the respective devices.

17. The information providing service method of claim 16, wherein each of the devices performs device authentication through the information provision server, and then automatically transmits its own device information to the information provision server when the device connects to a wired/wireless access point (AP) prepared on the network.

18. The information providing service method of claim 15, wherein the sensing means uses a human body sensor or a wired/wireless sensor switch.

19. The information providing service method of claim 15, wherein, in the specific place, a guide and information provision service for at least one of a building, a historic site and an object is provided.

20. The information providing service method of claim 15, further comprising, after (e), receiving, at the information provision application installed on the device corresponding to the searched device position information, the guide information data transmitted from the information provision server and displaying the guide information data on a screen such that the corresponding user can see the guide information data.
